(19) United States
(12) Patent Application Publication
(10) Pub. No.: US 2025/0118232 A1
(43) Pub. Date: Apr. 10, 2025

(54) ELECTRONIC DEVICE AND CONTROLLING METHOD THEREOF

(71) Applicant: Samsung Electronics Co., Ltd., Suwon-si (KR)

(72) Inventors: Juyeon LEE, Suwon-si (KR); Hyojin KIM, Suwon-si (KR); Jeewoo NOH, Suwon-si (KR); Seungjoon LEE, Suwon-si (KR); Yeeun CHOI, Suwon-si (KR)

(21) Appl. No.: 18/774,001

(22) Filed: Jul. 16, 2024

Related U.S. Application Data
(63) Continuation of application No. PCT/KR2024/009003, filed on Jun. 27, 2024.

(30) Foreign Application Priority Data
Oct. 6, 2023 (KR) 10-2023-0133734

(51) Int. Cl. G09G 3/00; G06T 7/70; G06V 20/56; G06V 40/10; G10L 25/51

(52) U.S. Cl. CPC G09G 3/001; G06T 7/70; G06V 20/56; G06V 40/10; G10L 25/51; G06T 2207/30261

(57) ABSTRACT

An electronic device and a controlling method thereof are provided. The electronic device includes a driving part configured to drive the electronic device, a microphone configured to receive audio, a camera, a projection part configured to project an image, memory storing one or more computer programs, and one or more processors communicatively coupled to the driving part, the microphone, the camera, the projection part, and the memory, wherein the or more computer programs include computer-executable instructions that, when executed by the one or more one processor s individually or collectively, cause the electronic device to obtain information about audio generated by an object located in an indoor space through the microphone while travelling through the driving part, and obtain an image of the object through the camera, obtain information about expected audio related to the object based on the image of the object, and store information about the audio generated by the object and information about the expected audio on a map corresponding to the indoor space, based on sound being detected within the indoor space, identify an object related to the detected sound based on information about audio stored on the map, and control the projection part to project a message including information about the sound based on information about the related object and the sound.

### CROSS-REFERENCE TO RELATED APPLICATION(S)

This application is a continuation application, claiming priority under § 365 (c), of an International application No. PCT/KR2024/009003, filed on Jun. 27, 2024, which is based on and claims the benefit of a Korean patent application number 10-2023-0133734, filed on Oct. 6, 2023, in the Korean Intellectual Property Office, the disclosure of which is incorporated by reference herein in its entirety.

### BACKGROUND

### Field

The disclosure relates to an electronic device and a controlling method thereof. More particularly, the disclosure relates to an electronic device capable of projecting a message including information about sound generated by an object while travelling.

### Description of the Related Art

Recently, various image contents have been provided through an electronic devices (e.g., a projector, or the like) that projects an image onto a wall or a separate screen. In particular, a recent projector may be not only capable of providing various image contents at a fixed location, but also configured to be mobile so that image contents can be provided in various spaces within a home.

In particular, users with weak hearing or users who are in a situation where they are unable to perceive sound (e.g., wearing earphones in their ears) may not be able to recognize sound generated within their home. This can result in users being unaware of an event occurring in their home and unable to react appropriately.

Therefore, there is a need to find a way to provide information related to sound generated in the home to users who have weak hearing or are unable to perceive sound.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device capable of projecting a message including information about sound generated by an object while travelling.

Additional aspects will be set forth in part in the description which follows and, in part, will be apparent from the description, or may be learned by practice of the presented embodiments.

In accordance with an aspect of the disclosure, an electronic device is provided. The electronic device includes a driving part configured to drive the electronic device, a microphone configured to receive audio, a camera, a projection part configured to project an image, memory storing one or more computer programs, and one or more processors communicatively coupled to the driving part, the microphone, the camera, the projection part, and the memory, wherein the one or more computer programs include computer-executable instructions that, when executed by the one or more processors individually or collectively, cause the electronic device to, obtain information about audio generated by an object located in an indoor space through the microphone while travelling through the driving part, and obtain an image of the object through the camera, obtain information about expected audio related to the object based on the image of the object, and store information about the audio generated by the object and information about the expected audio on a map corresponding to the indoor space, based on sound being detected within the indoor space, identify an object related to the detected sound based on information about audio stored on the map, and control the projection part to project a message including information about the sound based on information about the related object and the sound.

The electronic device further includes a communication interface, and wherein the one or more computer programs further include computer-executable instructions that, when executed by the one or more processors individually or collectively, cause the electronic device to obtain identification information of the object based on the image of the object, transmit the obtained identification information of the object to an external server through the communication interface, and obtain information about expected audio that could be generated by the object, from the external server.

The one or more computer programs further include computer-executable instructions that, when executed by the one or more processors individually or collectively, cause the electronic device to obtain information about urgent audio requiring an urgent response in relation to a location where the object is located, and store the urgent audio on a map corresponding to the indoor space.

The one or more computer programs further include computer-executable instructions that, when executed by the one or more processors individually or collectively, cause the electronic device to identify whether an object related to the detected sound exists based on information about audio stored on the map, based on identifying that an object related to the detected sound exists, identify whether the sound is generated by a registered human object or a registered inanimate object, based on identifying that the detected sound is sound generated by the registered human object, control the driving part to identify a location of the registered human object and move to the location of the human object, and based on the human object existing at the moved location, control the projection part to project a message including a text recognizing the sound around the human object.

The one or more computer programs further include computer-executable instructions that, when executed by the one or more processors individually or collectively, cause the electronic device to, based on the human object being an unregistered person or the human object not existing at the moved location, control the projection part to project a message including information about an estimated location of the human object and a text recognizing the sound.

The one or more computer programs further include computer-executable instructions that, when executed by the one or more processors individually or collectively, cause the electronic device to, based on identifying that the detected sound is sound generated by the registered inanimate object, determine an importance of the detected sound according to a pre-stored standard, and control the projection part to project a message including information about the sound at a current location or at a location where the sound is generated according to the importance of the detected sound.

The one or more computer programs further include computer-executable instructions that, when executed by the one or more processors individually or collectively, cause the electronic device to, based on identifying that the detected sound is urgent sound, determine that the sound has a first importance, based on a waveform of the detected sound being repeated more than a preset number of times, the detected sound being matched to audio including irregular noises among audio matched to the registered inanimate object, or the detected sound being identified as a call tone, determine that the sound has a second importance, and based on identifying that the sound has neither the first importance nor the second importance, determine that the sound has a third importance.

The one or more computer programs further include computer-executable instructions that, when executed by the one or more processors individually or collectively, cause the electronic device to, based on the importance of the detected sound being the first importance, control the driving part to output a notification message to a user and move to a location where the detected sound is generated, and control the projection part to project a message including information about the sound at the location where the sound is generated, based on the importance of the detected sound being the second importance, output a message inquiring a user about whether to move to a location where the detected sound is generated, based on the user moving to the location where the detected sound is generated, control the projection part to project a message including information about the sound at the location where the sound is generated, and based on the user not moving to the location where the detected sound is generated, control the projection part to project a message including information about the location where the sound is generated and information about the sound, and based on the importance of the detected sound being the third importance, control the projection part to project a message including information about the sound at a current location, to the user.

The one or more computer programs further include computer-executable instructions that, when executed by the one or more processors individually or collectively, cause the electronic device to, based on identifying that the detected sound is sound generated by the unregistered inanimate object, identify an importance of the detected sound based on at least one of a magnitude of the detected sound or a duration of the detected sound.

The one or more computer programs further include computer-executable instructions that, when executed by the one or more processors individually or collectively, cause the electronic device to, based on the importance of the detected sound being the first importance, control the driving part to output a notification message to a user and move to the location where the detected sound is generated, and control the projection part to project a message including information about the sound at the location where the sound is generated, based on the importance of the detected sound being the second importance, control the projection part to project a message including information about the sound in a direction corresponding to the location where the sound is generated by a current location, and based on the importance of the detected sound being the third importance, output no message.

In accordance with another aspect of the disclosure, a method of controlling an electronic device is provided. The method includes obtaining information about audio generated by an object located in an indoor space through a microphone while the electronic device is travelling, and obtaining an image of the object through a camera, obtaining information about expected audio related to the object based on the image of the object, and storing information about the audio generated by the object and information about the expected audio on a map corresponding the indoor space, based on sound being detected within the indoor space, identifying an object related to the detected sound based on information about audio stored on the map, and projecting a message including information about the sound based on information about the related object and the sound.

The storing of the information about the audio includes obtaining identification information of the object based on the image of the object, transmitting the obtained identification information of the object to an external server, and obtaining information about expected audio that could be generated by the object, from the external server.

The storing of the information about the audio includes obtaining information about urgent audio requiring an urgent response in relation to a location where the object is located, and storing the urgent audio on a map corresponding to the indoor space.

The identifying of the object includes identifying whether an object related to the detected sound exists based on information about audio stored on the map, and based on identifying that an object related to the detected sound exists, identifying whether the sound is generated by a registered human object or a registered inanimate object, and the projecting includes, based on identifying that the detected sound is sound generated by the registered human object, identifying a location of the registered human object and moving to the location of the human object, and based on the human object existing at the moved location, projecting a message including a text recognizing the sound around the human object.

The projecting of the message includes, based on the human object being an unregistered person or the human object not existing at the moved location, projecting a message including information about an estimated location of the human object and a text recognizing the sound.

The identifying of the object includes, based on identifying that the detected sound is sound generated by the registered inanimate object, determining an importance of the detected sound according to a pre-stored standard, and the projecting includes projecting a message including information about the sound at a current location or at a location where the sound is generated according to the importance of the detected sound.

The identifying of the object includes, based on identifying that the detected sound is urgent sound, determining that the sound has a first importance, based on a waveform of the detected sound being repeated more than a preset number of times, the detected sound being matched to audio including irregular noises among audio matched to the registered inanimate object, or the detected sound being identified as a call tone, determining that the sound has a second importance, and based on identifying that the sound has neither the first importance nor the second importance, determining that the sound has a third importance.

The projecting of the message includes, based on the importance of the detected sound being the first importance, outputting a notification message to a user and moving to a location where the detected sound is generated, and projecting a message including information about the sound at the location where the sound is generated, based on the importance of the detected sound being the second importance, outputting a message inquiring a user about whether to move to a location where the detected sound is generated, based on the user moving to the location where the detected sound is generated, projecting a message including information about the sound at the location where the sound is generated, and based on the user not moving to the location where the detected sound is generated, projecting a message including information about the location where the sound is generated and information about the sound, and based on the importance of the detected sound being the third importance, projecting a message including information about the sound at a current location, to the user.

The identifying of the object includes, based on identifying that the detected sound is sound generated by the unregistered inanimate object, identifying an importance of the detected sound based on at least one of a magnitude of the detected sound or a duration of the detected sound.

The projecting of the message includes, based on the importance of the detected sound being the first importance, outputting a notification message to a user and moving to the location where the detected sound is generated, and projecting a message including information about the sound at the location where the sound is generated, based on the importance of the detected sound being the second importance, projecting a message including information about the sound in a direction corresponding to the location where the sound is generated by a current location, and based on the importance of the detected sound being the third importance, outputting no message.

In accordance with another aspect of the disclosure, one or more non-transitory computer-readable storage media storing computer-executable instructions that, when executed by one or more processors of an electronic device individually or collectively, cause the electronic device to perform operations are provided. The operations include obtaining information about audio generated by an object located in an indoor space through the microphone while the electronic device is travelling, and obtaining an image of the object through a camera, obtaining information about expected audio related to the object based on the image of the object, and storing information about the audio generated by the object and information about the expected audio on a map corresponding the indoor space, based on sound being detected within the indoor space, identifying an object related to the detected sound based on information about audio stored on the map, and projecting a message including information about the sound based on information about the related object and the sound.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a view illustrating a system that projects a message including information about sound detected within a home according to an embodiment of the disclosure;

FIG. 2 is a block diagram illustrating configuration of an electronic device according to an embodiment of the disclosure;

FIG. 3 is a flowchart provided to explain a controlling method of an electronic device that projects a message including information about sound detected within a home according to an embodiment of the disclosure;

FIG. 4A is a flowchart provided to explain a method for storing on a map information about audio generated by an object, which is obtained through a microphone according to an embodiment of the disclosure;

FIG. 4B is a view provided to explain a method for storing on a map information about audio generated by an object, which is obtained through a microphone according to an embodiment of the disclosure;

FIG. 5A is a flowchart provided to explain a method for storing on a map information about expected audio that could be generated by an object, which is obtained based on an image obtained through a camera according to an embodiment of the disclosure;

FIG. 5B is a view provided to explain a method for storing on a map information about expected audio that may be generated by an object, which is obtained based on an image obtained through a camera according to an embodiment of the disclosure;

FIG. 6A is a flowchart provided to explain a method for storing on a map information about urgent audio related to a place where an object is located according to an embodiment of the disclosure;

FIG. 6B is a view provided to explain a method for storing on a map information about urgent audio related to a place where an object is located according to an embodiment of the disclosure;

FIG. 7 is a flowchart provided to explain a method for training and storing a neural network model based on information about audio and expected audio generated by an object according to an embodiment of the disclosure;

FIG. 8 is a view provided to explain a method for identifying a location where sound is generated according to an embodiment of the disclosure;

FIG. 9 is a flowchart provided to explain a controlling method of an electronic device that projects a message including information about sound in various ways according to whether the sound generated within a home is registered audio according to an embodiment of the disclosure;

FIGS. 10A and 10B are views provided to explain a message including information about sound related to a human object according to various embodiments of the disclosure;

FIG. 11 is a flowchart provided to explain a method for determining an importance of sound related to a registered inanimate object according to an embodiment of the disclosure;

FIG. 12 is a flowchart provided to explain a method for providing a message based on an importance of sound related to a registered inanimate object according to an embodiment of the disclosure;

FIG. 13 is a flowchart provided to explain a method for determining an importance of sound related to an unregistered inanimate object according to an embodiment of the disclosure;

FIG. 14 is a flowchart provided to explain a method for providing a message based on an importance of sound related to an unregistered inanimate object according to an embodiment of the disclosure;

FIG. 15 is a view provided to explain a method for providing a message including information related to sound generated in in a separated space within a home according to an embodiment of the disclosure;

FIG. 16 is a view provided to explain a method for providing a message including information about sound related to a failure of an object according to an embodiment of the disclosure;

FIG. 17 is a view provided to explain a method for providing a message including information about sound related to urgent audio according to an embodiment of the disclosure;

FIGS. 18A and 18B are views provided to explain a method for providing a message when sound related to an inanimate object and a human object are sequentially generated according to various embodiments of the disclosure;

FIG. 19 is a view provided to explain a method for providing a message including information about sound generated in a display device according to an embodiment of the disclosure; and

FIGS. 20, 21A, and 21B are views provided to explain a method for providing a message including information related to a noise generated within a home according to various embodiments of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the disclosure, the expressions “have”, “may have”, “include” or “may include” used herein indicate existence of corresponding features (e.g., elements, such as numeric values, functions, operations, or components), but do not exclude presence of additional features.

In the disclosure, the expressions “A or B”, “at least one of A or/and B”, or “one or more of A or/and B”, and the like may include any and all combinations of one or more of the items listed together. For example, the term “A or B”, “at least one of A and B”, or “at least one of A or B” may refer to all of the case (1) where at least one A is included, the case (2) where at least one B is included, or the case (3) where both of at least one A and at least one B are included.

Expressions “first”, “second”, “1^{st},” “2^{nd},” or the like, used in the disclosure may indicate various components regardless of sequence and/or importance of the components, will be used only in order to distinguish one component from the other components, and do not limit the corresponding components.

When it is described that an element (e.g., a first element) is referred to as being “(operatively or communicatively) coupled with/to” or “connected to” another element (e.g., a second element), it should be understood that it may be directly coupled with/to or connected to the other element, or they may be coupled with/to or connected to each other through an intervening element (e.g., a third element).

In contrast, when an element (e.g., a first element) is referred to as being “directly coupled with/to” or “directly connected to” another element (e.g., a second element), it should be understood that there is no intervening element (e.g., a third element) in-between.

An expression “˜configured (or set) to” used in the disclosure may be replaced by an expression, for example, “suitable for,” “having the capacity to,” “˜designed to,” “˜adapted to,” “˜made to,” or “˜capable of” depending on a situation. A term “˜configured (or set) to” may not necessarily mean “specifically designed to” in hardware.

Instead, an expression “˜an apparatus configured to” may mean that an apparatus “is capable of” together with other apparatuses or components. For example, a “processor configured (or set) to perform A, B, and C” may mean a dedicated processor (e.g., an embedded processor) for performing the corresponding operations or a generic-purpose processor (e.g., a central processing unit (CPU) or an application processor) that may perform the corresponding operations by executing one or more software programs stored in memory apparatus.

In various embodiments of the disclosure, a “module” or a “unit” may perform at least one function or operation, and be implemented by hardware or software or be implemented by a combination of hardware and software. In addition, a plurality of “modules” or a plurality of “units” may be integrated into at least one module and be implemented by at least one processor except for a ‘module’ or a ‘unit’ that needs to be implemented by specific hardware.

Meanwhile, various elements and regions in the drawings are schematically drawn. Therefore, the technical concept of the disclosure is not limited by a relative size or spacing drawn in the accompanying drawings.

Hereinafter, various embodiments of the disclosure will be described with reference to the accompanying drawings.

It should be appreciated that the blocks in each flowchart and combinations of the flowcharts may be performed by one or more computer programs which include computer-executable instructions. The entirety of the one or more computer programs may be stored in single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

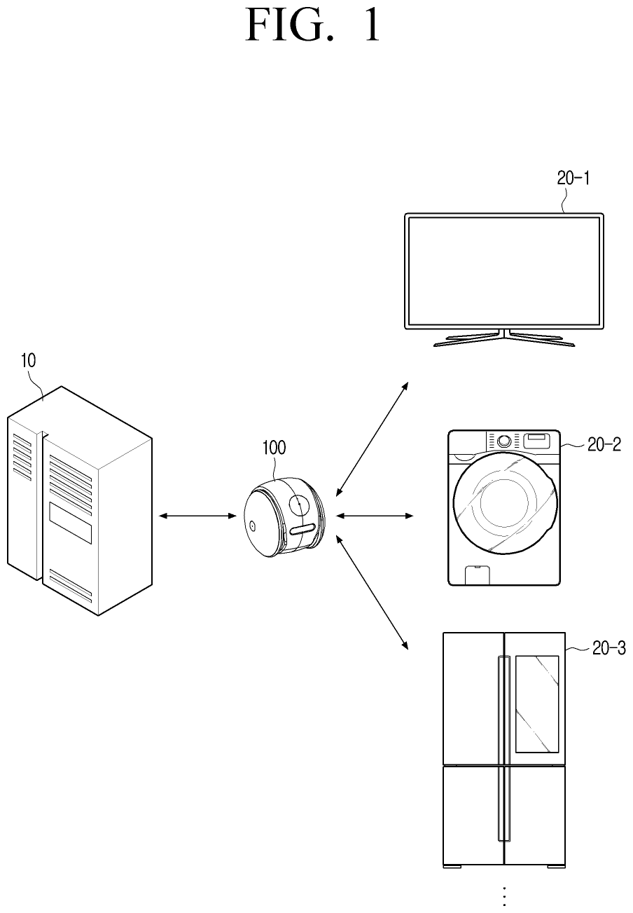

FIG. 1 is a view illustrating a system that projects a message including information about sound detected within a home according to an embodiment of the disclosure.

Referring to FIG. 1, the system may include a server 10, an electronic device 100, and a plurality of external devices 20-1, 20-2, 20-3. Here, the server 10 may be implemented as at least one server. In addition, the electronic device 100 may be implemented as a mobile projector, but is not limited thereto, and may also be implemented as a mobile device (e.g., a robot cleaner, a serving robot, or the like). Further, the external device may be implemented as the television (TV) 20-1, the washing machine 20-2, the refrigerator 20-3, or the like, as shown in FIG. 1, but this is only one example, and may be implemented as various home appliances or internet of things (IoT) devices located within a home. In this case, the server 10, the electronic device 100, and the plurality of external devices 20-1, 20-2, 20-3 may be communicatively connected to each other.

The electronic device 100 may register at least one user. Specifically, the electronic device 100 may register a primary user (e.g., a user with weak hearing, or the like) based on a user input, and may register a family member (or other nearby members) of the primary user. Further, the electronic device 100 may obtain and store information about the primary user and the family members thereof (e.g., relationship information with the primary user, voice information, or the like).

In addition, the electronic device 100 may generate a map of an indoor space based on sensing information acquired through at least one sensor (e.g., a time-of-flight (ToF) sensor, a lidar sensor, or an inertial measurement unit (IMU) sensor, or the like) and images acquired through a camera. The indoor space may be a space in a home, but this is only one example, and may consist of various indoor spaces (e.g., a space in a restaurant, or the like). Further, the map may include an illustration representing a state of an indoor space on a plane by scaling it down to a certain ratio. According to embodiments of the disclosure, the map may include an illustration showing a plan structure within a home, which is reduced to a certain ratio and represented by a designated symbol. For example, the map may include an illustration representing a plan structure within a home with lines. However, the map is not limited thereto, and may also include locations of key objects within the home.

In addition, the electronic device 100 may obtain and store information about audio related to an object located in an indoor space on a generated map. According to an embodiment of the disclosure, the electronic device 100 may acquire information about audio generated by an object, which is acquired through a microphone while travelling and store the information on the map. In this case, the electronic device 100 may acquire information about the audio generated by the object through microphones provided on the plurality of external devices 20-1, 20-2, 20-3 as well as the microphone provided on the electronic device 100. According to an embodiment of the disclosure, the electronic device 100 may acquire information about expected audio that could be generated by an object based on an image of the object captured while travelling, and store the information on the map. Specifically, the electronic device 100 may transmit to a server 10 an image of the object (or identification information of the object obtained from the image), which is captured while travelling. The server 10 may transmit to the electronic device 100 information about expected audio that could be generated by the object based on the captured image of the object (or identification information of the object obtained from the image). The electronic device 100 may store the information about the expected audio transmitted by the server 10 on a map. According to an embodiment of the disclosure, the electronic device 100 may obtain information about urgent audio requiring an urgent response in association with a location where an object is located and store the information on a map. Specifically, the electronic device 100 may receive from the server 10 information about urgent audio that requires an urgent response related to the location where the object is located and store the information on the map.

After storing the information about the audio related to the object on the map, the electronic device 100 may detect sound originating from an indoor space. In this case, the electronic device 100 may detect (or monitor) sound generated in the indoor space while travelling around a user in the indoor space (e.g., within a threshold distance from the primary user).

When the occurrence of sound is detected, the electronic device 100 may identify an object related to the detected sound using a map that stores information about audio related to the object. Based on the information about the identified object, the electronic device 100 may identify information about a location where the detected sound is generated. The electronic device 100 may project a message including information about the object related to the detected sound and information about the sound based on the detected sound. Various embodiments of projecting a message including information about the detected sound will be described with reference to the accompanying drawings below.

As described above, by providing a message related to an object using a map that stores information about audio related to the object, it is possible to provide information about sound generated in the home to users with weak hearing or users who are in a situation where they are unable to perceive sound. As a result, the users with weak hearing or the users who are in a situation where they are unable to perceive sound may quickly react to various events occurred in their home.

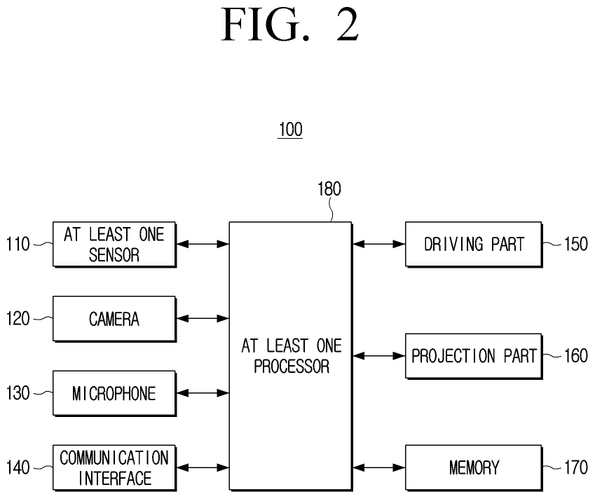

FIG. 2 is a block diagram illustrating configuration of an electronic device according to an embodiment of the disclosure.

Referring to FIG. 2, the electronic device 100 may include at least one sensor 110, a camera 120, a microphone 130, a communication interface 140, a driving part 150, a projection part 160, memory 170, and at least one processor 180. Meanwhile, the configuration of the electronic device 100 is not limited to the configuration shown in FIG. 2, and other configurations apparent to those skilled in the art may be added or deleted. For example, the electronic device 100 may have additional configurations, such as speakers, displays, and the like, and some of the configurations shown in FIG. 2 may be deleted.

The at least one sensor 110 may acquire various information about a state of the electronic device 100 or a surrounding environment of the electronic device 100. In particular, the at least one sensor 110 may include a time of flight (ToF) sensor and an inertial measurement unit (IMU) sensor. The ToF sensor may project light (e.g., laser, near infrared light, visible light, ultraviolet light, or the like) onto an object and detect light reflected by the object to obtain sensing information to obtain information about a distance from the object. The IMU sensor is a sensor for detecting movement of the electronic device 100, and may include at least one of a geomagnetic sensor, an acceleration sensor, and a gyro sensor. However, as described above, utilizing a lidar sensor to obtain information about the distance from the object is only one example, and information about the distance from the object may be obtained using various sensors, such as a depth sensor, and the like. In particular, the at least one processor 180 may generate a map of an indoor space based on the sensing information obtained through the ToF sensor and the IMU sensor.

The camera 120 may photograph the surroundings of the electronic device 100 to obtain an image of an object located in the indoor space. The electronic device 100 may obtain identification information (e.g., type of object, size of object, shape of object, or the like) of the object by inputting the image of the object to a trained neural network model (e.g., an object recognition model). In this case, the trained neural network model may be stored in the memory 170, but this is only one example, and the trained neural network model may be stored in the external server 10.

The microphone 130 is configured to receive audio generated from an object (for example, human voice, audio generated from an inanimate object, or the like) and convert it into audio data. The microphone 130 may receive audio in an activated state. In particular, the microphone 130 may include a plurality of microphones formed in the direction of the top, front, side, or the like, of the electronic device 100. The microphone 130 may include various components, such as a microphone that collects audio in the form of analog, an amplification circuit that amplifies the collected sound, an analog-to-digital (A/D) conversion circuit that samples the amplified sound and converts it into a digital signal, a filter circuit that removes noise components from the converted digital signal, or the like.

More particularly, the microphone 130 may include a plurality of microphones, and may identify a direction in which sound is received based on the volume and reception time of the sound received through the plurality of microphones.

The communication interface 140 includes at least one circuit and may perform communication with various types of external devices. The communication interface 140 may include at least one of a Bluetooth low energy (BLE) module, a Wi-Fi communication module, a cellular communication module, a third generation (3G) mobile communication module, a fourth generation (4G) mobile communication module, a fourth generation long term evolution (LTE) communication module, or a fifth generation (5G) mobile communication module.

In particular, the communication interface 140 may transmit an image (or identification information of an object) captured by the camera 120 to the server 10, and can receive information from the server 10 about expected or urgent audio that could be generated by the object. In addition, the communication interface 140 may receive information from the external device 20 about audio (or sound) generated by the object. In this case, the electronic device 100 may perform communication with the server 10 through a first type of communication interface (e.g., a far-field communication interface), and may perform communication with the external device 20 through a second type of communication interface (e.g., a near-field communication interface).

The driving part 150 is configured to drive the electronic device 100. In particular, the driving part 150 may include wheels and a driving portion to move the electronic device 100. The driving part may generate and transmit a physical force to the wheels included in the electronic device 100. In particular, the driving part 150 may be moved to a location where sound is generated under the control of the at least one processor 180.

The projection part 160 is configured to project an image externally. According to various embodiments of the disclosure, a projection part 212 may be implemented in various projection methods (e.g., a cathode-ray tube (CRT) method, a liquid crystal display (LCD) method, a digital light processing (DLP) method, a laser method, or the like). In addition, the projection part 160 may perform various functions to adjust an output image under the control of the at least one processor 180. For example, the projection part 160 may perform functions, such as zoom, keystone, quick-corner (four-corner) keystone, lens shift, and the like. In particular, the projection part 160 may provide a message including information related to the sound. The message is intended to guide the user through information related to the sound, and may be referred to as a UI, a guide window, a guide screen, or the like.

Meanwhile, in the above-described embodiment of the disclosure, the electronic device 100 projects a message through the projection part 160, but this is only one example, and the electronic device 100 may output a message through an output portion, such as a display or the like.

The memory 170 may store instructions or data related to an operating system (OS) for controlling the overall operations of the components of the electronic device 100 and the components of electronic device 100. In particular, the memory 170 may include a plurality of modules for generating a map including information about audio related to an object and providing information related to the sound using the generated map. In particular, when functions for generating a map including information about audio related to an object and using the generated map to provide a message including information about the sound are executed, the electronic device 100 may load data for various modules to perform various operations, which is stored in non-volatile memory, onto volatile memory. Here, ‘loading’ refers to an operation of calling and storing data stored in the non-volatile memory, in the volatile memory, so that the at least one processor 180 can access the data.

More particularly, the memory 170 may store information about a map generated by the at least one processor 180. In this case, the map may include not only information about an object (e.g., identification information about the object, location information about the object, or the like) but also information about audio related to the object (e.g., audio generated by the object, expected audio that could be generated by the object, urgent audio that could be generated at a location related to the object, or the like).

In addition, the memory 170 may store data for various neural network models. For example, the memory 170 may store a neural network model trained to obtain identification information of an object included in an image by inputting the image or a neural network model trained to obtain information about an object related to sound by inputting the detected sound. However, this is only one example, and the neural network model may be stored in the external server 10.

Further, the memory 170 may include a speech-to-text (STT) module for converting a user voice into a text. However, this is only one example, and the STT module may be stored in an external server.

Meanwhile, the memory 170 may be implemented as non-volatile memory (e.g., hard disk, solid state drive (SSD), flash memory), volatile memory (which may also include memory within the at least one processor 180), or the like.

The at least one processor 180 may control the electronic device 100 according to at least one instruction stored in the memory 170.

In particular, the at least one processor 180 may include one or more processors. Specifically, the one or more processors may include one or more of a central processing unit (CPU), a graphics processing unit (GPU), an accelerated processing unit (APU), a many integrated core (MIC), a digital signal processor (DSP), a neural processing unit (NPU), a hardware accelerator, or a machine learning accelerator. The one or more processors may control one or any combination of the other components of the electronic device 100, and may perform communication-related operations or data processing. The one or more processors may execute one or more programs or instructions stored in memory. For example, the one or more processors may perform a method according to an embodiment by executing one or more instructions stored in the memory.

When a method according to an embodiment includes a plurality of operations, the plurality of operations may be performed by one processor or by a plurality of processors. In other words, when a first operation, a second operation, and a third operation are performed by the method according to an embodiment of the disclosure, all of the first operation, the second operation, and the third operation may be performed by the first processor, or the first operation and the second operation may be performed by the first processor (e.g., a general-purpose processor) and the third operation may be performed by the second processor (e.g., an artificial intelligence-dedicated processor). For example, the electronic device 100 may perform the operation of generating a map or the operation of providing a message using a general-purpose processor, and may perform the operation of obtaining recognition information of an object or the operation of identifying an object using an artificial intelligence-dedicated processor.

The one or more processors may be implemented as a single core processor comprising a single core, or as one or more multicore processors including a plurality of cores (e.g., homogeneous multicore or heterogeneous multicore). When the one or more processors are implemented as multicore processors, each of the plurality of cores included in a multicore processor may include processor internal memory, such as cache memory and on-chip memory, and a common cache shared by the plurality of cores may be included in the multicore processor. Further, each of the plurality of cores (or some of the plurality of cores) included in the multi-core processor may independently read and perform program instructions to implement the method according to an embodiment of the disclosure, or all (or some) of the plurality of cores may be coupled to read and perform program instructions to implement the method according to an embodiment.

When a method according to an embodiment includes a plurality of operations, the plurality of operations may be performed by one core of a plurality of cores included in a multi-core processor, or may be performed by a plurality of cores. For example, when a first operation, a second operation, and a third operation are performed by a method according to an embodiment of the disclosure, all of the first operation, the second operation, and the third operation may be performed by the first core included in the multi-core processor, or the first operation and the second operation may be performed by the first core included in the multi-core processor and the third operation may be performed by the second core included in the multi-core processor.

In one or more embodiments of the disclosure, the at least one processor 180 obtains information about audio generated by an object located in an indoor space through the microphone 130 while travelling through the driving part 150 and obtains an image of the object through the camera 120. The at least one processor 180 obtains information about expected audio related to the object based on the image of the object, and stores the information about audio generated by the object and the information about expected audio on a map corresponding to the indoor space. When sound is detected within the indoor space, the at least one processor 180 identifies an object related to the detected sound based on the information about the audio stored on the map. The at least one processor 180 controls the projection part 160 to project a message including information about the sound based on information about the related object and the sound.

Hereinafter, a method for generating a map that stores information about audio related to an object, and projecting a message including information about sound detected within a home using the generated map will be described with reference to the accompanying drawings.

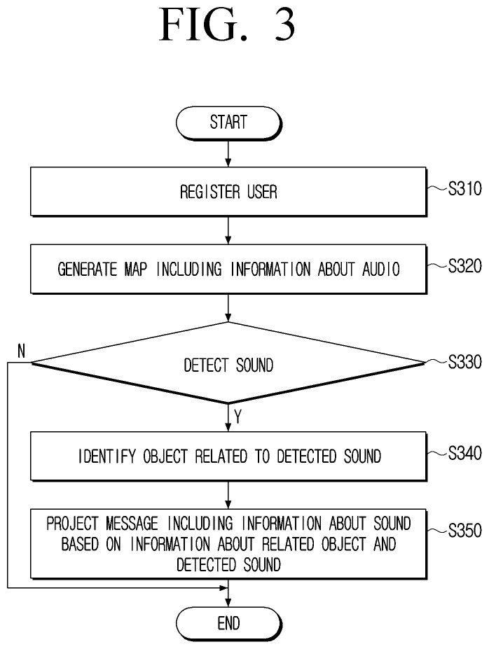

FIG. 3 is a flowchart provided to explain a controlling method of an electronic device that projects a message including information about sound detected within a home according to an embodiment of the disclosure.

Referring to FIG. 3, the electronic device 100 registers a user in operation S310. In this case, the user may register a primary user and a family member of the primary user (referred to as a “sub-user”). Here, the electronic device 100 may register the primary user and the family member through separate registration procedures. In this case, the electronic device 100 may store information about the primary user and the family member (e.g., identification information of the user, voice information of the user, or the like). Accordingly, the registered primary user and family member may be referred to as registered human objects.

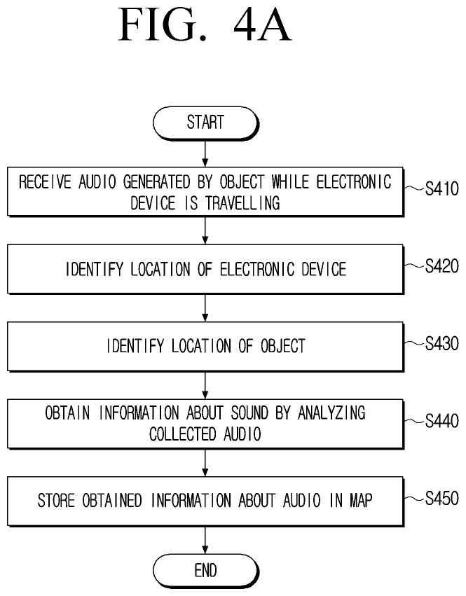

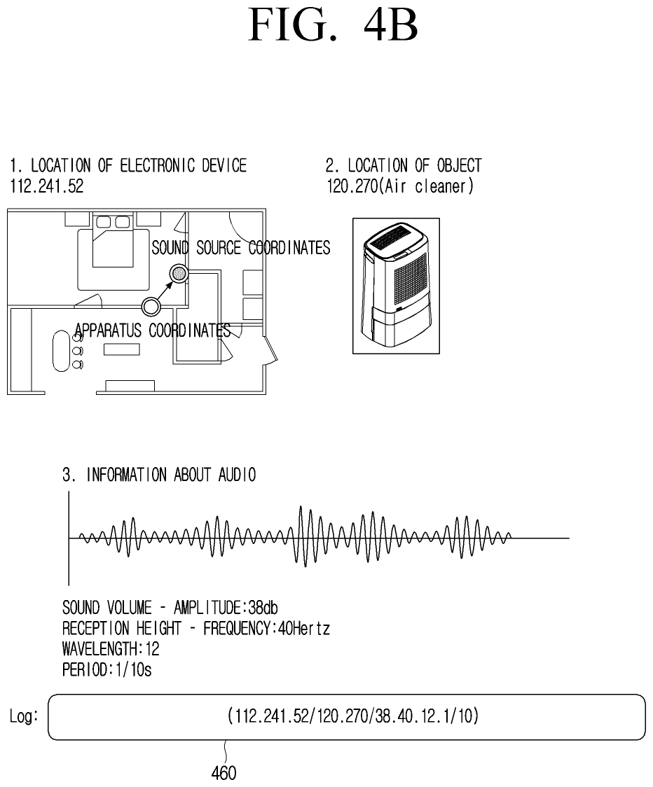

The electronic device 100 generates a map that includes information about audio in operation S320. Specifically, the electronic device 100 may store not only information about an object on a map (e.g., identification information of the object, or the like) but also information about audio related to the object. A method for generating a map that includes information about audio will be described with reference to FIGS. 4A, 4B, 5A, 5B, 6A, 6B, and 7.

Through operations S310 and S320, the electronic device 100 may generate a map for providing a message that includes information related to the sound.

After the map is generated, the electronic device 100 identifies whether sound has been detected in operation S330. In particular, the electronic device 100 may detect the occurrence of sound within a home while travelling around the primary user. In this case, the sound may be sound of more than a preset volume, but is not limited thereto.

When it is identified that sound has been detected in operation S330-Y, the electronic device 100 identifies an object related to the detected sound in operation S340. In other words, the electronic device 100 may identify an object related to the detected sound based on the detected sound and information about audio related to the object stored on the map. In this case, the sound may include audio generated by a plurality of objects, but the electronic device 100 may identify an object generating audio that has the greatest volume (or amplitude) among the audio generated by the plurality of objects. In addition, the electronic device 100 may identify a location where the detected sound is generated based on the identified location of the object.

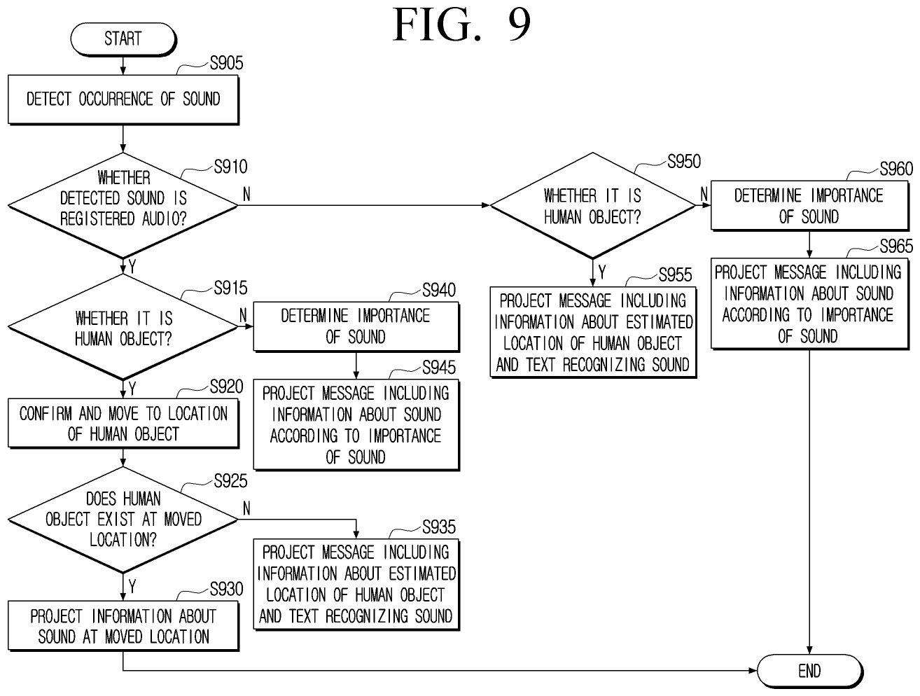

The electronic device 100 projects a message including information about the sound based on information about the related object and the detected sound in operation S350. Specifically, the electronic device 100 may project a message including information about the sound in various places or in various ways based on the information about the related object and the sound, which will be described with reference to FIGS. 9, 10A, 10B, and 11 to 14.

FIG. 4A is a flowchart provided to explain a method for storing on a map information about audio generated by an object, which is obtained through a microphone according to an embodiment of the disclosure.

FIG. 4B is a view provided to explain a method for storing on a map information about audio generated by an object, which is obtained through a microphone according to an embodiment of the disclosure.

Referring to FIGS. 4A and 4B, firstly, the electronic device 100 may receive audio generated by an object while the electronic device 100 is travelling in operation S410. Specifically, when a user command to generate a map is input, the electronic device 100 may receive audio generated by an object while the electronic device 100 is travelling to generate the map. In this case, the electronic device 100 may receive audio generated by an object while the electronic device 100 is travelling for map generation, but this is only one example, and the electronic device 100 may receive audio generated by an object during normal driving.

The electronic device 100 may identify a location of the electronic device 100 in operation S420. In other words, when audio generated by an object is received, the electronic device 100 may identify a location of the electronic device 100 that receives the audio generated by the object based on sensing information obtained through the at least one sensor 110 (e.g., an IMU sensor). In this case, the location of the electronic device 100 receiving the audio may be referred to as a collection location of the electronic device 100. The location of the electronic device 100 may be represented with reference to a map of an indoor space (an x coordinate, a y coordinate, and a rotation direction). For example, the location of the electronic device 100 may be represented as (112, 241, 52) as shown in FIG. 4B, as the location of the electronic device 100 receiving the audio generated by the object.

The electronic device 100 may identify a location of an object in operation S430. In particular, the electronic device 100 may identify a location of an object generating audio based on sensing information acquired through the at least one sensor 110 (e.g., an IMU sensor and a ToF sensor, or the like). In this case, the electronic device 100 may obtain information about a relative location between the electronic device 100 and the object generating the audio (i.e., a distance between the electronic device 100 and the object, or the like) from a sensing value obtained through the ToF sensor. Subsequently, the electronic device 100 may identify a location of the object based on the location of the electronic device 100 and the information about the relative location between the electronic device 100 and the object generating the audio obtained in operation S420. In this case, the location of the object may be represented as (an x coordinate, a y coordinate) on a map of the indoor space. For example, the electronic device 100 may represent the location of the object as (120, 270) as shown in FIG. 4B.

The electronic device 100 may obtain information about audio by analyzing collected audio in operation S440. Specifically, the electronic device 100 may collect audio generated by an object and analyze the collected audio. Subsequently, the electronic device 100 may obtain and store information about the volume (or amplitude), pitch (or frequency), wavelength, and period of the audio. For example, as shown in FIG. 4B, the electronic device 100 may store a volume of 38 dB, a pitch of 40 Hz, a wavelength of 12, and a period of 1/10s as information about the audio.

The electronic device 100 may store information about acquired audio on the map in operation S450. Specifically, the electronic device 100 may obtain identification information of an object (e.g., an air purifier) based on an image captured through the camera 120, and store information about audio generated by the object on the map based on the identification information of the object. In this case, the electronic device 100 may match information about the location of the electronic device 100, the location of the object, and the audio and store the same in the form of log data (or metadata). For example, the electronic device 100 may match and store information about the location of the electronic device 100, the location of the object, and the audio as log data 460, such as (112.241.52/10.270/38.40.12.1/10), as shown in FIG. 4B. In this case, the operation of the electronic device 100 storing information about the acquired audio on the map may have the same meaning as the operation of registering the acquired audio with the electronic device 100.

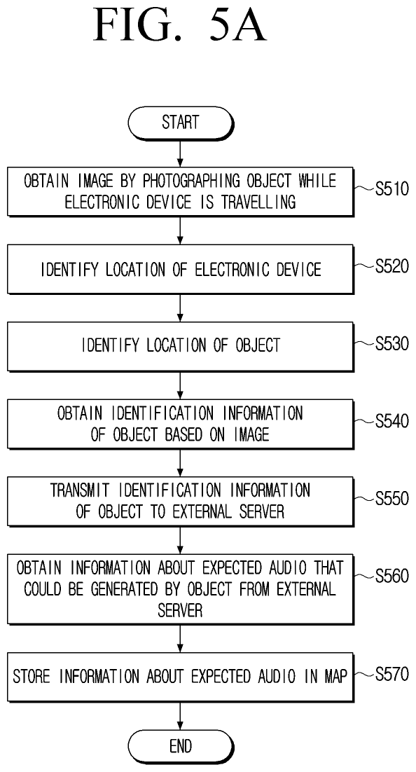

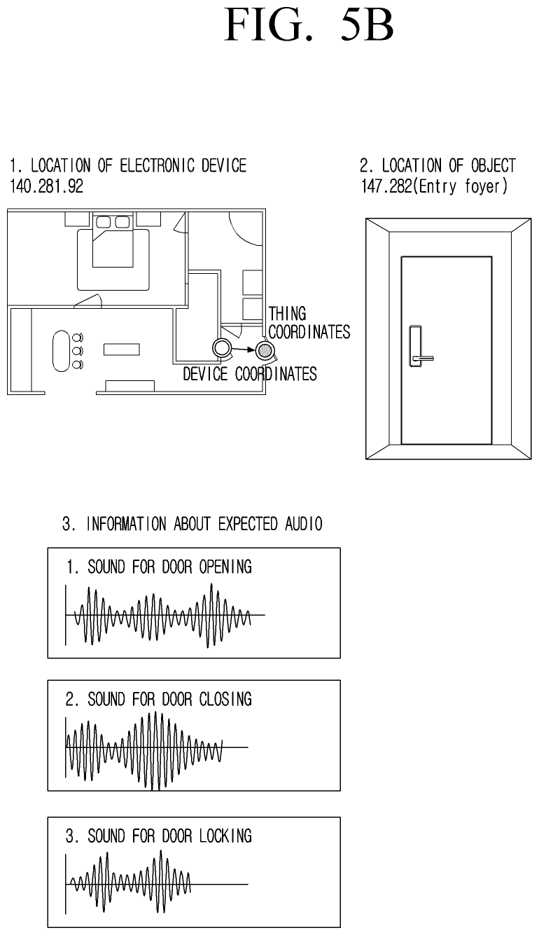

FIG. 5A is a flowchart provided to explain a method for storing on a map information about expected audio that could be generated by an object, which is obtained based on an image obtained through a camera according to an embodiment of the disclosure.

FIG. 5B is a view provided to explain a method for storing on a map information about expected audio that may be generated by an object, which is obtained based on an image obtained through a camera according to an embodiment of the disclosure.

Referring to FIGS. 5A and 5B, firstly, the electronic device 100 may acquire an image by photographing an object while the electronic device 100 is traveling in operation S510. Specifically, when a user command for generating a map is input, the electronic device 100 may acquire an image by photographing the object through the camera 120 while the electronic device 100 is traveling for generating the map. In this case, the electronic device 100 may acquire the image by photographing the object while the electronic device 100 is travelling for map generation, but this is only one example, and the image may be acquired during normal driving.

The electronic device 100 may identify a location of the electronic device 100 in operation S520. In other words, in the case of photographing an object, the electronic device 100 may identify the location of the electronic device 100 photographing the object based on sensing information obtained through the at least one sensor 110 (e.g., an IMU sensor). In this case, the location of the electronic device 100 photographing the object may be referred to as the shooting location of the electronic device 100. The location of the electronic device 100 may be represented as (x coordinate, y coordinate, rotation direction) with reference to a map of the indoor space. For example, the location of the electronic device 100 may be represented by (140, 281, 92), as shown in FIG. 5B, as the location of the electronic device 100 that receives audio generated by the object.

The electronic device 100 may identify a location of the object in operation S530. In particular, the electronic device 100 may identify the location of the photographed object based on sensing information acquired through the at least one sensor 110 (e.g., the IMU sensor and the ToF sensor, or the like). In this case, the electronic device 100 may obtain information about a relative location between the electronic device 100 and the photographed object from a sensing value acquired through the ToF sensor. Subsequently, the electronic device 100 may identify the location of the object based on the information about the location of the electronic device 100 and the relative location between the electronic device 100 and the photographed object obtained in operation S520. In this case, the location of the object may be represented as an (x coordinate, y coordinate) on a map of the indoor space. For example, the electronic device 100 may represent the location of the object as (147, 282), as shown in FIG. 5B.

The electronic device 100 may obtain identification information of the object based on an image in operation S540. Specifically, the electronic device 100 may obtain identification information of the object included in an image by inputting the image of the object to a trained neural network model (e.g., an object recognition model). Alternatively, the electronic device 100 may transmit an image capturing the object to an external server and receive from the external server identification information of the object obtained by a neural network model stored in the external server. The identification information of the object may include not only the type of object (e.g., air purifier, or the like) but also various information, such as a product name of the object, a manufacturing date of the object, or the like.

The electronic device 100 transmits the identification information of the object to an external server in operation S550. In this case, the external server 10 may be a cloud server that stores information about expected audio that could be generated by the object.

The electronic device 100 may obtain information about expected audio that could be generated by the object, from an external server in operation S560. For example, when the photographed object is an “entrance door object,” the electronic device 100 may obtain expected audio, such as the sound of the entrance door opening, the sound of the entrance door closing, and the sound of the door locking, as shown in FIG. 5B. The information about the expected audio may include information about the volume (or amplitude), pitch (or frequency), wavelength, and period of the expected audio, as previously described in FIG. 4A.

The electronic device 100 may store information about expected audio on a map in operation S570. Specifically, the electronic device 100 may store information about expected audio that could be generated by an object on the map based on identification information of the object. In this case, the electronic device 100 may match the information about the location of the electronic device 100, the location of the object, and the expected audio and store the same in the form of log data, as shown in FIG. 4A.

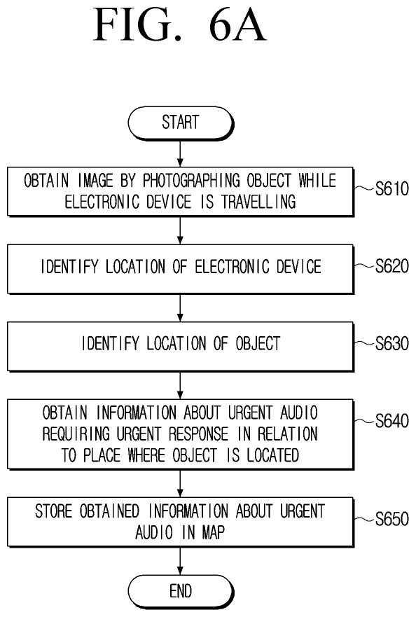

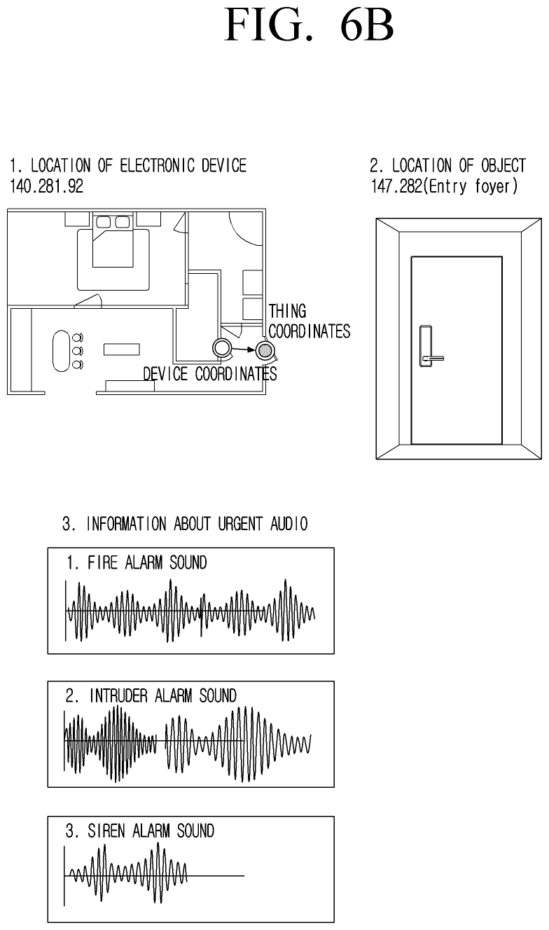

FIG. 6A is a flowchart provided to explain a method for storing on a map information about urgent audio related to a place where an object is located according to an embodiment of the disclosure. Meanwhile, operations S610 to S630 illustrated in FIG. 6A are the same as operations S510 to S530 described in FIG. 5A, and thus duplicative description is omitted.

FIG. 6B is a view provided to explain a method for storing on a map information about urgent audio related to a place where an object is located according to an embodiment of the disclosure.

Referring to FIGS. 6A and 6B, the electronic device 100 may obtain information about urgent audio that is related to a place where an object is located and requires an urgent response in operation S640. Specifically, the electronic device 100 may obtain identification information of the object by inputting an image capturing the object to a neural network model, and identify a place where the object is located base on the identification information of the object. Subsequently, the electronic device 100 may obtain information about the urgent audio related to the place where the object is located among information about urgent audio pre-stored in the electronic device 100. Alternatively, the electronic device 100 may obtain identification information of the object by inputting an image capturing the object to a neural network model. Subsequently, the electronic device 100 may transmit the identification information of the object to an external server, and may receive information about urgent audio related to the location of the object from the external server. For example, when the object included in the captured image is a “entrance door object,” the electronic device 100 may obtain urgent audio, such as a fire alarm sound, an intruder alarm sound, a siren alarm sound, or the like, as urgent audio related to the place where the entrance door is located (e.g., an entrance), as shown in FIG. 6B. In this case, the information about the urgent audio may include information about the volume (or amplitude), pitch (or frequency), wavelength, and period of the urgent audio, as previously described in FIG. 4A. As another example, when the object included in the captured image is a “window object,” the electronic device 100 may obtain urgent audio, such as gas leak alarm sound, carbon monoxide alarm sound, or the like, as urgent audio related to the place where the window is located (e.g., a porch). As another example, when the object included in the captured image is a “gas stove object,” the electronic device 100 may obtain urgent audio, such as a gas stove alarm sound or the like as urgent related to the place where the gas stove is located (e.g., a kitchen).

The electronic device 100 may store information about urgent audio on a map in operation S650. Specifically, the electronic device 100 may store information about urgent audio that may be generated by an object on the map based on identification information of the object. In this case, the electronic device 100 may match the location of the electronic device 100, the location of the object, and the information about the urgent audio and store the same in the form of log data, as described in FIG. 4A.

As described in FIGS. 5A, 5B, 6A, and 6B, the electronic device 100 may store not only audio directly generated by an object but also expected audio that could be generated by the object or urgent audio related to the object, thereby obtaining and storing various audio related to the object and accordingly, the user may be able to react more quickly and accurately to various events that could occur urgently.

Meanwhile, information about various audio acquired through FIGS. 4A, 4B, 5A, 5B, 6A, and 6B may be stored on the map in the form of log data, but this is only one example, and various audio acquired through FIGS. 4A, 4B, 5A, 5B, 6A, and 6B may be used as learning data to train a neural network model.

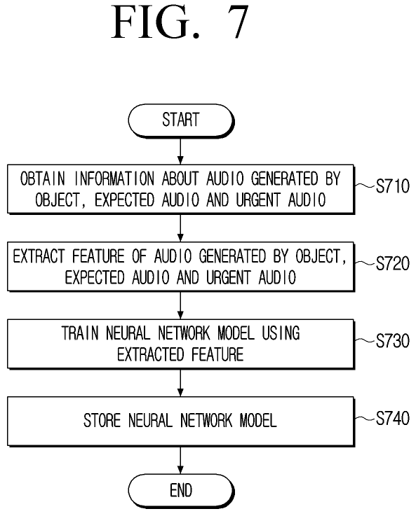

FIG. 7 is a flowchart provided to explain a method for training and storing a neural network model based on information about audio and expected audio generated by an object according to an embodiment of the disclosure.

Referring to FIG. 7, the electronic device 100 may obtain information about the object occurring audio, the expected audio, and the urgent audio in operation S710. The information about the object occurring audio, the expected audio, and the urgent audio has been described in FIGS. 4A, 4B, 5A, 5B, 6A, and 6B, so redundant description will be omitted.

The electronic device 100 may extract features of the audio, the expected audio, and the urgent audio generated by the object in operation S720. The features may be referred to as feature data or feature values, and may be values (or data) that image each of the audio, the expected audio, and the urgent audio generated by the object based on information about the audio, the expected audio, and the urgent audio generated by the object.

The electronic device 100 trains a neural network model using the extracted features in operation S730. In this case, the neural network model may be a neural network model trained to output information about the object corresponding to each of the audio, the expected audio, and the urgent audio generated by the object by taking the features corresponding to the audio, the expected audio, and the urgent audio generated by the object as input values.

The electronic device 100 may store the trained neural network model in operation S740. Later, the electronic device 100 may use the stored neural network model to obtain information about an object related to sound detected within an indoor space (identification information of the object, location information of the object, or the like).

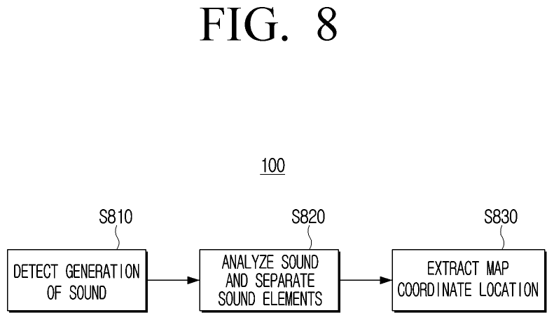

FIG. 8 is a view provided to explain a method for identifying a location where sound is generated according to an embodiment of the disclosure.

Referring to FIG. 8, the electronic device 100 may detect the occurrence of sound in operation S810. In this case, the sound may be acquired while the electronic device 100 is traveling after the electronic device 100 has created a map storing audio related to an object. In this case, the sound may include audio generated from a plurality of objects. In particular, according to an embodiment of the disclosure, the electronic device 100 may detect the occurrence of sound above a preset volume while travelling around the primary user.

The electronic device 100 may analyze the sound to separate sound elements included in the sound in operation S820. Specifically, the detected sound may include sound elements that are audio generated from a plurality of objects. For example, the detected sound may include a first sound element generated from an air conditioner, a second sound element generated from an air purifier, and a third sound element generated from an object that is not a registered object. The electronic device 100 may analyze the detected sound to separate the three sound elements included in the sound. In this case, the electronic device 100 may identify the loudest sound element among the plurality of sound elements. Subsequently, the electronic device 100 may compare the identified sound elements with information about audio stored on the map to identify an object related to the detected sound. For example, when the detected sound includes the first sound element generated from an air conditioner, the second sound element generated from an air purifier, and the third sound element generated from an object that is not a registered object, the electronic device 100 may identify the second sound element that is the loudest among the first to third sound elements. Subsequently, the electronic device 100 may compare the second sound element with information about the audio stored on the map to identify the object related to the detected sound as an air purifier.

The electronic device 100 may extract a map coordinate location in operation S830. Specifically, when an object related to the detected sound is identified, the electronic device 100 may extract location information of the object related to the sound based on log data of the object related to the detected sound stored on the map.

Through the above-described method, the electronic device 100 may obtain information about the object and the location of the object related to the sound detected while the electronic device 100 is traveling.

Meanwhile, the above-described embodiments describe a method for identifying the location of an object registered with the electronic device 100, but this is only one example, and the locations of the objects not registered with the electronic device 100 may also be identified (or estimated). Specifically, the electronic device 100 may identify the direction in which sound is received based on the volume of the sound received through a plurality of microphones and the time of reception. In addition, the electronic device 100 may identify information about a location where an object related to the sound is estimated to be located based on the direction in which the sound is received.

FIG. 9 is a flowchart provided to explain a controlling method of an electronic device that projects a message including information about sound in various ways according to whether the sound generated within a home is registered audio according to an embodiment of the disclosure.

Referring to FIG. 9, the electronic device 100 may detect the occurrence of sound in operation S905. In other words, the electronic device 100 may detect the occurrence of sound above a preset volume while travelling around the primary user.

The electronic device 100 may identify whether the detected sound is registered audio in operation S910. Specifically, the electronic device 100 may identify whether the detected sound is registered audio based on the detected sound and log data stored on the map or information about a pre-stored user voice. In other words, the electronic device 100 may identify whether the detected sound is registered audio by searching log data stored on the map for log data that includes information about audio that is the same as the detected sound. Alternatively, the electronic device 100 may identify whether the detected sound is registered audio by identifying whether the detected sound is the same as a pre-stored user voice.

When it is determined that the detected sound is registered audio in operation S910-Y, the electronic device 100 may identify whether the object related to the detected sound is a human object in operation S915. Specifically, the electronic device 100 may identify whether the object related to the detected sound is a human object based on user voice information registered in operation S310 of FIG. 3. For example, when it is determined that the voice identical to the detected sound among pre-stored user voice information is an older brother of the primary user, the electronic device 100 may identify that the object related to the detected sound is a “brother object”.

When it is identified that the object related to the detected sound is a human object in operation S915-Y, the electronic device 100 may confirm the location of the human object and move to the location in operation S920. Specifically, the electronic device 100 may confirm the location of the human object based on the direction of the detected sound, and may move to the confirmed location.

The electronic device 100 may identify whether a human object is present at the moved location in operation S930. Specifically, the electronic device 100 may identify whether a human object is present by continuously detecting ambient sound at the moved location or by photographing the surroundings of the moved location. For example, the electronic device 100 may identify whether a “brother object” is present at the moved location by identifying whether the voice of the “brother object” detected at the moved location continues to be detected or whether an image taken at the moved location includes the “brother object”.

When it is identified that a human object is present at the moved location in operation S925-Y, the electronic device 100 may project a message including information about sound at the moved location in operation S940. In this case, the electronic device 100 may recognize sound detected through an STT module to obtain a text corresponding to the detected sound. Subsequently, the electronic device 100 may generate a message including information about the obtained text, and may project the generated message at the moved location. In this case, the generated message may be projected in a direction where the primary user is located. Specifically, the electronic device 100 may project the message by rotating from the moved location toward the primary user in order to project the generated message in the direction of the primary user. In this case, the text included in the generated message may be arranged to be readable by the primary user.

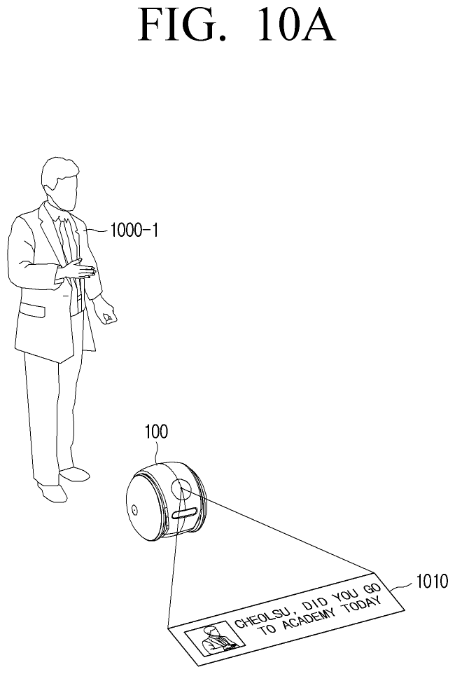

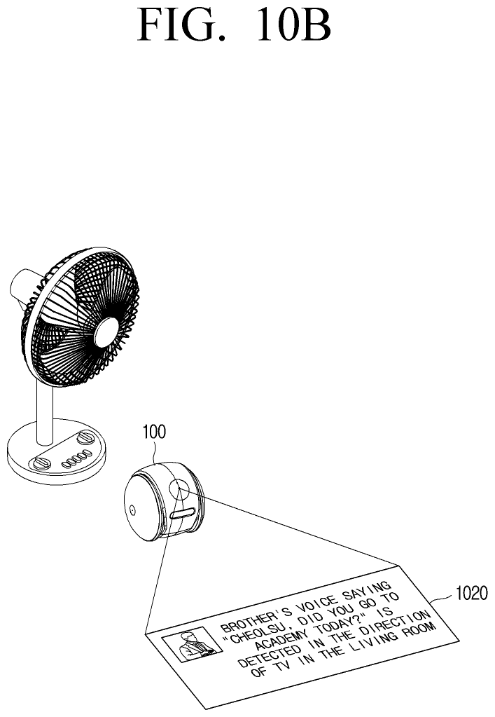

FIGS. 10A and 10B are views provided to explain a message including information about sound related to a human object according to various embodiments of the disclosure.

Referring to FIG. 10A, the electronic device 100 may project a message 1010 including a text corresponding to sound around a human object 1000-1, “Cheolsu, did you go to academy today?”, in the direction of the primary user.

When it is identified that a human object is not present at the moved location in operation S930-N, the electronic device 100 may project a message including information about the estimated location of a human object and a text recognizing sound in operation S935. Specifically, the electronic device 100 may identify the direction in which the sound is received based on the volume of the sound and the time of reception of the sound received through a plurality of microphones. In addition, the electronic device 100 may obtain information about an estimated location of a human object related to the sound based on the direction in which the sound is received. The electronic device 100 may generate a message including a text corresponding to the sound obtained through the STT module along with information about the estimated location where the human object related to the sound is located, and may project the generated message. For example, as shown in FIG. 10B, the electronic device 100 may project a message 1020, “A voice saying, “Cheolsu, did you go to academy today?”, has been detected in the direction of the living room fan”, in the direction of the primary user, which includes information about the human object, information about the estimated location of the human object, and the recognized text at the moved location.

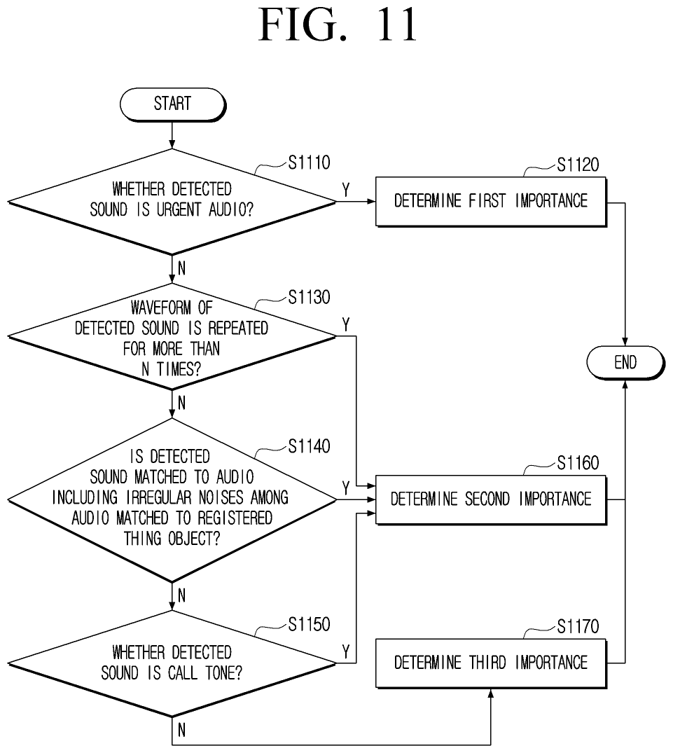

When it is identified that the object related to the detected sound is not a human object in operation S915-N (i.e., when it is identified that the object related to the detected sound is an inanimate object), the electronic device 100 may determine the importance of the sound in operation S940. In this case, the importance of the sound may mean the degree to which the sound generated by the inanimate object requires rapid confirmation by the user. A method for determining the importance of sound by the electronic device 100 will be described with reference to FIG. 11.

FIG. 11 is a flowchart provided to explain a method for determining an importance of sound related to a registered inanimate object according to an embodiment of the disclosure.

Referring to FIG. 11, the electronic device 100 may identify whether the detected sound is urgent audio in operation S1110. In other words, the electronic device 100 may identify whether the detected sound among the audio stored on the map is urgent audio that requires a rapid response at the location related to the detected sound.

When it is identified that the detected sound is urgent audio in operation S1110-Y, the electronic device 100 may determine the importance of the detected sound as first importance in operation S1120. In this case, the sound of the first importance may be sound that requires a rapid response from the user. For example, when the detected sound is gas leak alarm sound from the kitchen or fire alarm sound from the entrance door, the electronic device 100 may determine the importance of the detected sound as the first importance.

When it is identified that the detected sound is not urgent audio in operation S1110-N, the electronic device 100 may identify whether the waveform of the detected sound is repeated more than n times in operation S1130. For example, audio in which the waveform of the detected sound is repeated more than n times may be audio, such as a refrigerator door opening alarm sound, a door lock not closing sound, a microwave food completion notification sound, or the like.

When the waveform of the detected sound is repeated more than n times in operation S1130-Y, the electronic device 100 may determine the importance of the detected sound as second importance in operation S1160. In this case, the sound of the second importance may be sound that requires a response, but not a rapid response from the user.

When the waveform of the detected sound is not repeated more than n times in operation S1130-N, the electronic device 100 may identify whether the detected sound matches audio that includes an irregular noise among the audios that match registered inanimate objects in operation S1140. For example, the audio including an irregular noise among the audios that match registered inanimate objects may be audio that includes an irregular noise, such as the sound of striking metal (e.g., a key, or the like) in a washing machine, the sound of a motor failing in a refrigerator or robotic vacuum cleaner, or the like.

When the detected sound is matched to audio that includes an irregular noise among the audios matched to the registered inanimate objects in operation S1140-Y, the electronic device 100 may determine the importance of the detected sound as the second importance in operation S1160.

When the detected sound is not matched to audio that includes an irregular noise among the audios matched to the registered inanimate objects in operation S1140-N, the electronic device 100 may identify whether the detected sound is a call tone in operation S1150. For example, the call tone may be audio, such as call tone of an entrance door, an intercom call tone at a front door, or a call tone set by the user.

When the detected sound is a call tone in operation S1150-Y, the electronic device 100 may determine the importance of the detected sound as the second importance in operation S1160.

When the detected sound is not a call tone in operation S1150-N, the electronic device 100 may determine the importance of the detected sound as third importance in operation S1170. In other words, when the detected sound is not urgent audio, audio with a waveform repeated more than n times, audio that includes an irregular noise among the audio matched to the registered objects, or a call tone, the electronic device 100 may determine the importance of the detected sound as third importance. In this case, the sound of the third importance may be sound that does not require a user response. For example, the sound of the third importance may be motion sound of an object that may occur in everyday life.

Meanwhile, the above-described criteria for dividing the importance levels are only one example, and the importance levels may be further simplified or subdivided. For example, the first importance and the second importance may be simplified into one importance, and various audio included in the second importance may be further subdivided into a plurality of levels of importance.

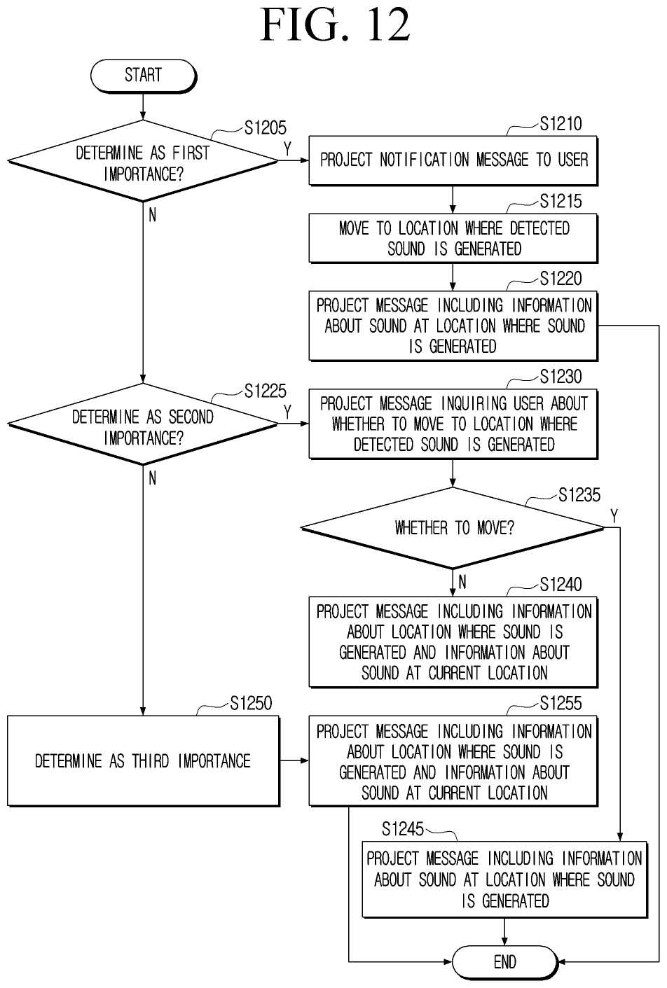

Referring back to FIG. 9, the electronic device 100 may project a message including information about sound based on the importance of the sound in operation S945. In this case, the electronic device 100 may project a message including information about the sound at the current location or at the location where the sound is generated, depending on the importance of the detected sound, which will be described with reference to FIG. 12.

FIG. 12 is a flowchart provided to explain a method for providing a message based on an importance of sound related to a registered inanimate object according to an embodiment of the disclosure.

Referring to FIG. 12, when it is determined that the detected sound is of the first importance in operation S1205-Y, the electronic device 100 may project a notification message to the user in operation S1210. In this case, the electronic device 100 may output a notification message to inform the user of an emergence situation for a rapid response. For example, the electronic device 100 may project a notification message indicating that urgent audio has been detected on a screen of a preset color (e.g., red) while rotating 360 degrees from the current location. In addition, the electronic device 100 may include in the notification message information about the urgent audio (e.g., the location where the urgent audio was generated, the volume of the urgent audio, or the like) and information guiding the user to move to the location where the urgent audio was generated, and may output a light emitting diode (LED) warning light, an alarm sound, or the like, along with the notification message.

The electronic device 100 may move to the location where the detected sound was generated in operation S1215. In other words, the electronic device 100 may move to the location where the detected sound was generated in order to guide the user's rapid response. For example, when the detected sound is gas leak alarm sound, the electronic device 100 may move to the kitchen.

The electronic device 100 may project a message including information about the sound at the location where the sound was generated in operation S1220. Specifically, the electronic device 100 may project a message including information about the urgent audio (e.g., the type of the urgent audio, the volume of the urgent audio, or the like) and information about how to respond at the location where the sound was generated. For example, after moving to the kitchen, the electronic device 100 may output a message stating, “Gas leak alarm sound of 100 dB was generated. Please check the gas, turn off the gas valve, and open a window.”

When it is determined that the detected sound is not of the first importance in operation S1205-N, but of the second importance in operation S1225-Y, the electronic device 100 may project a message to the user asking whether to move to the location where the detected sound was generated in operation S1230. Specifically, the electronic device 100 may project a message to the user asking whether to move to the location where the sound was generated along with information about the detected sound. For example, the electronic device 100 may project a message stating, “Strange sound is coming from the refrigerator in the kitchen. Do you want to move to the location where the sound was generated? Yes/No”.

The electronic device 100 may identify whether the user is moving in operation S1235. In this case, the electronic device 100 may identify whether the user is moving based on a voice uttered by the user, but this is only one example, and the electronic device 100 may identify whether the user is moving based on the user's movement.

When it is identified that the user is not moving in operation S1235-N, the electronic device 100 may project a message that includes information about the location where the sound was generated and information about the sound at the current location in operation S1240. For example, the electronic device 100 may project a message at the current location in the direction of the user stating, “The sound of a malfunctioning motor is coming from the refrigerator located in the kitchen, and needs to be checked.”

When it is identified that the user is moving in operation S1235-Y, the electronic device 100 may project a message including information about the sound at the location where the sound was generated in operation S1245. Specifically, the electronic device 100 may move with the user to the location where the sound was generated, and may project a message including information about the sound at the location where the sound was generated. For example, the electronic device 100 may move with the user to the kitchen, and project a message stating, “The sound of a malfunctioning motor is coming from the refrigerator, and needs to be checked.”

When it is determined that the detected sound is not of the second importance in operation S1225-N, the electronic device 100 may determine that the detected sound is of the third importance in operation S1250. The electronic device 100 may project a message to the user, which includes information about the location where the sound was generated and information about the sound at the current location in operation S1255. For example, the electronic device 100 may project a message that includes information about the sound, such as “The air conditioner in the living room is running in no air mode” at the current location.

Meanwhile, depending on importance, the electronic device 100 may display the size, boldness, color, or the like, of the text included in the projected message differently, or provide a separate indicator, or the like. For example, the electronic device 100 may display the text to be larger, bolder and in a reddish color as the importance increases, and may display the text to be smaller, thinner and in a blackish color as the importance decreases. Alternatively, the electronic device 100 may display an indicator, such as “emergency”, “confirmation required”, or the like, depending on importance.

Referring back to FIG. 9, when it is determined that the detected sound is not registered audio in operation S910-N, the electronic device 100 may identify whether the detected sound is a human object in operation S950. In other words, the electronic device 100 may identify whether the sound generated from an unregistered object is sound generated from a human object.

When it is identified that the detected sound was generated from a human object in operation S950-Y, the electronic device 100 may project a message including information about the estimated location of the human object and the text that recognized the sound in operation S955. Specifically, the electronic device 100 may generate a message that includes text corresponding to the sound acquired through the STT module along with information about the estimated location of the human object related to the sound, and project the generated message. For example, the electronic device 100 may project a message in the direction of the primary user, which includes information about the estimated location of the human object and text that recognizes the detected sound, such as “A voice saying “Is your mother home?” was detected from the direction of the entrance door.” at the current location.

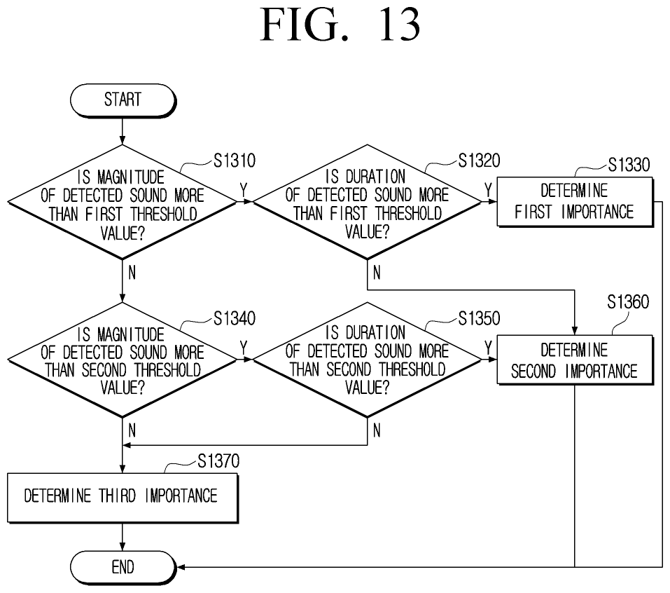

When it is identified that the detected sound was not generated from a human object in operation S950-N (i.e., when it is identified that the detected sound was generated from an inanimate object), the electronic device 100 may determine the importance of the sound in operation S960. In this case, the electronic device 100 may identify the importance of the detected sound based on at least one of the volume of the detected sound or the duration of the detected sound, which will be described with reference to FIG. 13.

FIG. 13 is a flowchart provided to explain a method for determining an importance of sound related to an unregistered inanimate object according to an embodiment of the disclosure.

Referring to FIG. 13, the electronic device 100 may identify whether the volume of the detected sound is equal to or greater than a first threshold value in operation S1310. In this case, the first threshold value may be a value related to the volume of the sound generated in association with an urgent situation, and may be, for example, 120 dB.

When the volume of the detected sound is equal to or greater than the first threshold value in operation S1310-Y, the electronic device 100 may identify whether the duration of the detected sound is equal to or greater than first threshold time in operation S1320. For example, the first threshold time may be 10 seconds.

When the volume of the detected sound is equal to or greater than the first threshold value in operation S1310-Y and the duration of the detected sound is equal to or greater than the first threshold time in operation S1320-Y, the electronic device 100 may determine that the detected sound is of the first importance in operation S1330. For example, the sound of the first importance among the sound generated from an unregistered object may be sound that requires a response, such as siren sound, baby-crying sound, dog-barking sound, or the like.

When the duration of the detected sound is less than the first threshold time in operation S1320-N, the electronic device 100 may determine that the detected sound is of the second importance in operation S1360.

When the volume of the detected sound is less than the first threshold value in operation S1310-N, the electronic device 100 may identify whether the volume of the detected sound is equal to or greater than a second threshold value in operation S1340. In this case, the second threshold value may be a value related to the volume of the sound in association with an event requiring confirmation, and may be, for example, 70 dB.

When the volume of the detected sound is equal to or greater than the second threshold value in operation S1340-Y, the electronic device 100 may identify whether the duration of the detected sound is equal to or greater than second threshold time in operation S1350. For example, the second threshold time may be 8 seconds. Meanwhile, the first threshold time and the second threshold time may be set differently, but this is only one example, and they may be set to the same time.

When the duration of the detected sound is equal to or greater than the second threshold time in operation S1350-Y, the electronic device 100 may determine that the detected sound is of the second importance in operation S1360. For example, the sound of the second importance among the sound generated from an unregistered object may be screams, objects hitting, objects falling, knocking, or the like.

When the volume of the detected sound is less than the second threshold value in operation S1340-N, or the duration of the detected sound is less than the second threshold time in operation S1350-N, the electronic device 100 may determine that the detected sound is of the third importance in operation S1370. For example, the sound of the third importance among the sound generated from an unregistered object may be ambient noise, white noise, or the like.

Meanwhile, in the above-described embodiments of the disclosure, the importance of the sound related to an unregistered object is determined using the volume and duration of the detected sound, but this is only one example, and the importance of the sound related to an unregistered object may be determined using only one of the volume and duration of the detected sound.

In addition, in the above-described embodiments of the disclosure, it is described that there are three levels of importance in the sound related to an unregistered object, but this is only one example, and the importance of the sound may be further simplified or subdivided than the three levels.

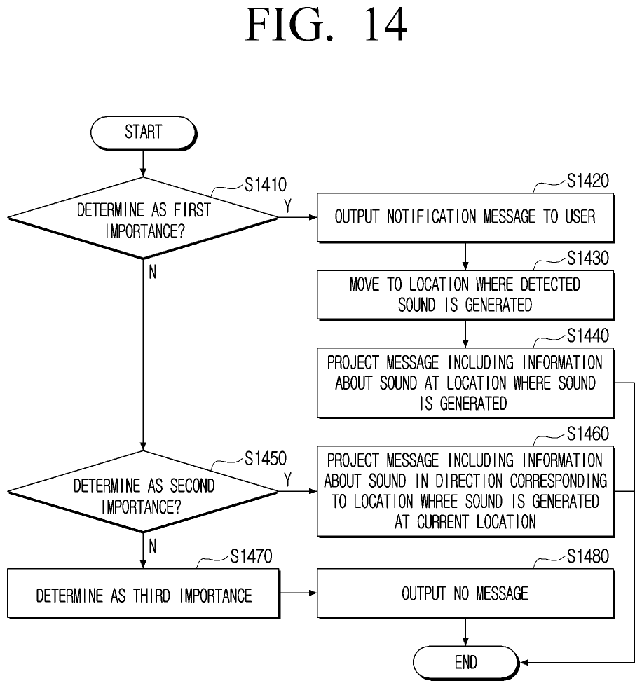

Referring back to FIG. 9, the electronic device 100 may project a message including information about the sound based on the importance of the sound in operation S965. In this case, the electronic device 100 may project a message including information about the sound at the current location or at the location where the sound was generated, depending on the importance of the detected sound, which will be described with reference to FIG. 14.

FIG. 14 is a flowchart provided to explain a method for providing a message based on an importance of sound related to an unregistered inanimate object according to an embodiment of the disclosure.

Referring to FIG. 14, when it is determined that the detected sound is of the first importance in operation S1410-Y, the electronic device 100 may project a notification message to the user in operation S1420. In this case, the electronic device 100 may project a notification message informing the user of an urgent situation for a rapid response. For example, the electronic device 100 may project a notification message indicating that urgent audio has been detected on a screen of a preset color (e.g., red) while rotating 360 degrees from the current location. In addition, the electronic device 100 may include in the notification message information about the urgent audio (e.g., the location where the urgent audio was generated, the volume of the urgent audio, or the like) and information guiding the user to move to the location where the urgent audio was generated, and may output an LED warning light, an alarm sound, or the like, along with the notification message.

The electronic device 100 may move to the location where the detected sound was generated in operation S1430. In other words, the electronic device 100 may move to the location where the detected sound was generated in order to guide the user's rapid response. For example, when the detected sound is siren sound, the electronic device 100 may move to a window.

The electronic device 100 may project a message including information about the sound at the location where the sound was generated in operation S1440. Specifically, the electronic device 100 may project a message including information about the urgent audio (e.g., the type of the urgent audio, the volume of the urgent audio, or the like) and information about how to respond at the location where the sound was generated. For example, after moving to the window, the electronic device 100 may output a message stating, “Siren sound of 128 dB was generated. Please open the window, check it out, and then evacuate”.

When it is determined that the detected sound is not of the first importance in operation S1410-N, but of the second importance in operation S1450-Y, the electronic device 100 may project a message including information about the sound in a direction corresponding to the location where the sound was generated, at the current location in operation S1460. For example, the electronic device 100 may project a message in the direction of the window stating, “There is a scream outside the window, which needs to be checked”, at the current location.

When it is determined that the detected sound is not of the second importance in operation S1450-N, the electronic device 100 may determine that the detected sound is of the third importance in operation S1470. The electronic device 100 may not output a message in operation S1480. In other words, the electronic device 100 may determine that the sound currently detected is a noise and may not output a separate message.

Hereinafter, a method for providing a message including information about sound detected by the electronic device 100 according to various embodiments will be described.

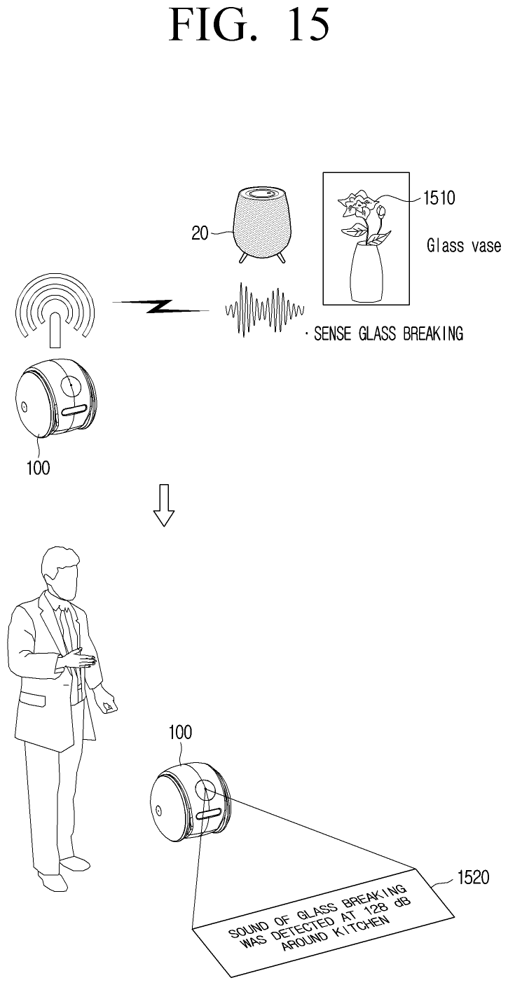

FIG. 15 is a view provided to explain a method for providing a message including information related to sound generated in in a separated space within a home according to an embodiment of the disclosure.

Referring to FIG. 15, specifically, the electronic device 100 may travel spaces within a home, but may not detect sound generated from every space within the home. For example, when the sound is generated from a space with a closed door, or when the sound is not detectable through the microphone 130 due to distance, the electronic device 100 may not detect the sound even if the sound is generated within the home. In this case, the electronic device 100 may detect the sound generated within the home through the external device 20 within the home. Here, the external device 20 may be a device that is registered to detect sound in the space where the external device 20 is located in association with the electronic device 100. In this case, the external device 20 may store information about a map that stores audio related to objects stored in the electronic device 100.

For example, as shown in FIG. 15, when the external device 20 (e.g., an AI speaker) located in the kitchen detects the sound of a breaking glass bottle 1510, the electronic device 100 may obtain information about the detected sound from the external device 20. In this case, the electronic device 100 may receive the sound detected by the external device 200, but this is only one example, and the electronic device 100 may obtain information about the sound analyzed by the external device 20 (e.g., information about the volume, pitch, wavelength, and period of the sound).

In addition, the electronic device 100 may provide a message including information about the sound based on the information about the sound received from the external device 20. For example, the electronic device 100 may project a message 1520, as shown in FIG. 15, that states, “Sound of breaking glass at 123 dB has been detected around the kitchen,” based on the object related to the sound and the sound.

In other words, the electronic device 100 may project a message including information about the sound in association with the external device 20 located within the home.

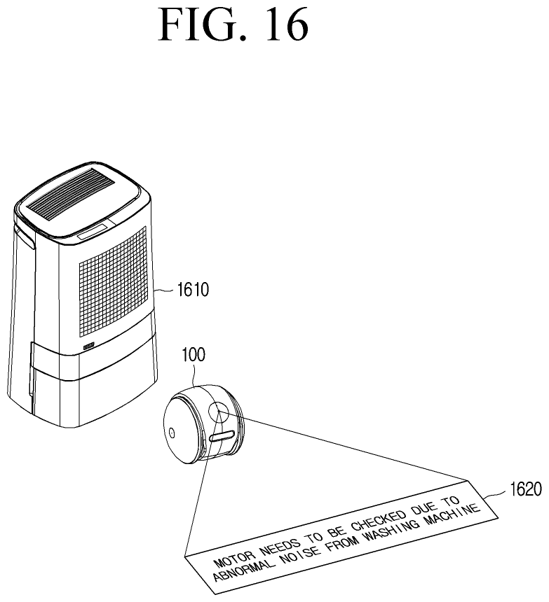

FIG. 16 is a view provided to explain a method for providing a message including information about sound related to a failure of an object according to an embodiment of the disclosure.

Referring to FIG. 16, specifically, the electronic device 100 may recognize information about possible failures or problematic situations that may occur in the electronic device 100 or existing home appliances in the home that are not connected to an AP within the home, and project a message to notify the information to the user.

Specifically, when an excessive noise is detected during a spin-drying operation in a washing machine 1610 that is an inanimate object within a home, the electronic device 100 may obtain information about the detected sound based on information about audio related to the washing machine stored in the electronic device 100. In other words, the electronic device 100 may identify the information about the detected sound by searching the information about audio related to the washing machine for sound related to a noise that may be generated during the spin-drying operation.

In addition, the electronic device 100 may output a message inquiring the user about whether to move to the space where the washing machine 1610 is located. When the user moves with the electronic device 100 to the space where the washing machine 1610 is located, the electronic device 100 may project a message 1620 in the direction of the user, such as “Due to an abnormal noise in the washing machine, the motor needs to be checked”, which is information related to the sound, as shown in FIG. 16.

In this case, the electronic device 100 may output a button or message for scheduling an after-sales service (A/S) appointment. Further, the electronic device 100 may provide data (e.g., a recording) regarding the generated noise to a terminal device of a repairer during A/S later, and play the generated noise to the repairer.

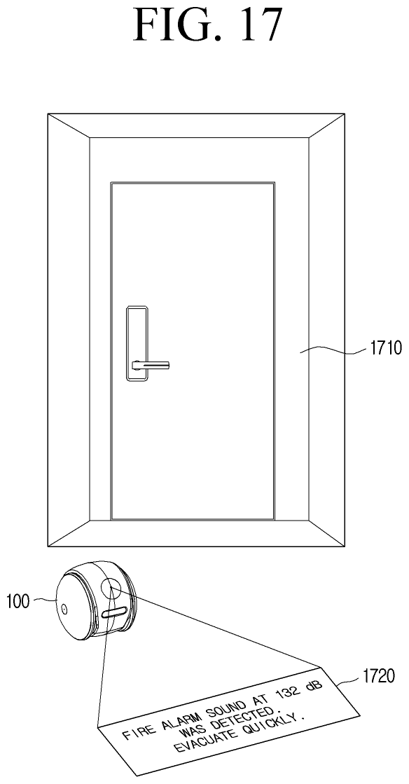

FIG. 17 is a view provided to explain a method for providing a message including information about sound related to urgent audio according to an embodiment of the disclosure.

Referring to FIG. 17, specifically, the electronic device 100 may store information about the audio at a specific location on a map, rather than storing the urgent audio on the map in relation to an object. Specifically, when storing information about the audio on the map, the electronic device 100 may analyze the object included within an image acquired through the camera 120 to obtain information about the area where the electronic device 100 is currently located. For example, when the objects included in the image include an entrance door, a shoe rack, shoes, and the like, the electronic device 100 may identify the area where the electronic device 100 is currently located as an entrance door. In addition, the electronic device 100 may store information about urgent audio related to the entrance at the entrance location on the map.

In addition, when sound corresponding to urgent audio is detected, the electronic device 100 may, based on information about the urgent audio stored on the map, move to a specific area of the map where the urgent audio is stored and project a message including information related to the sound. For example, when fire alarm sound is detected, the electronic device 100 may move to an entrance 1710 on the map of the home where information about the fire alarm sound is stored, as shown in FIG. 17, and project a message 1720, stating “Fire alarm sound at 132 dB was detected. Please evacuate quickly” at the entrance 1710.

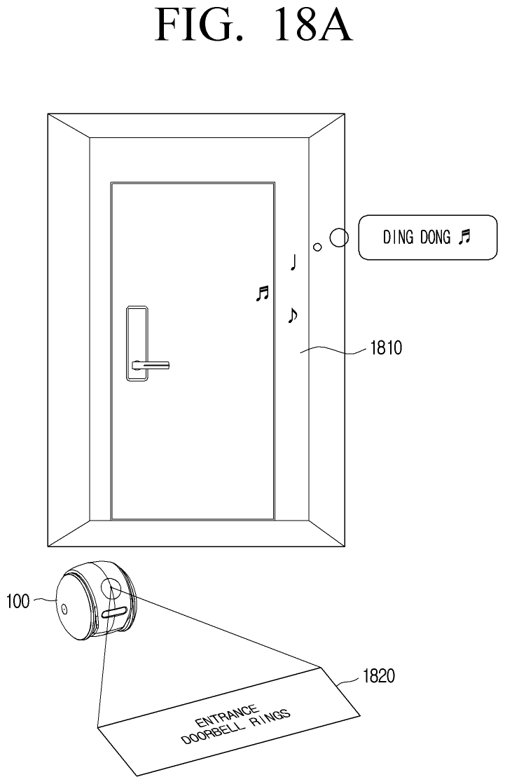

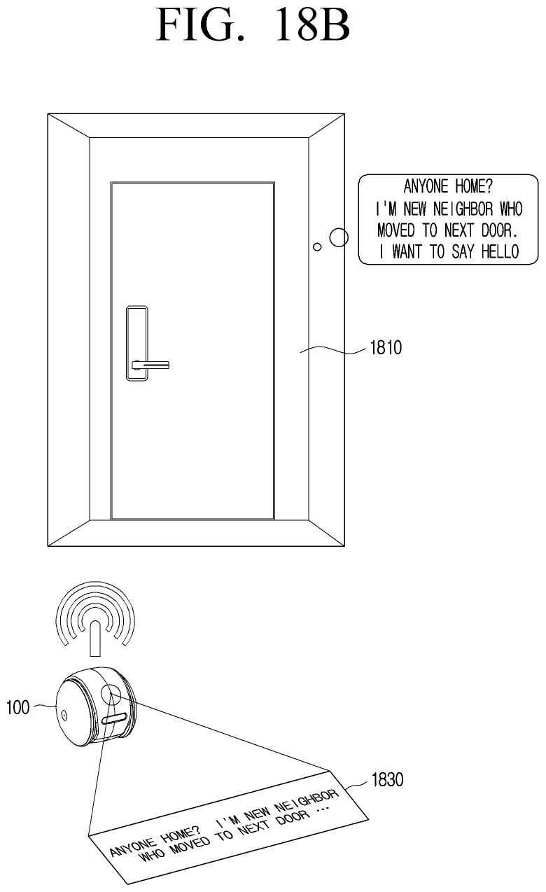

FIGS. 18A and 18B are views provided to explain a method for providing a message when sound related to an inanimate object and a human object are sequentially generated according to various embodiment of the disclosure.

When first sound related to an inanimate object and second sound related to a human object are generated sequentially, the electronic device 100 may sequentially provide a message including information about the first sound and the second sound.

Referring to FIG. 18A, when first sound corresponding to an entrance door ring is detected, the electronic device 100 may, based on information about the first sound, move to an entrance door 1810 where the first sound is detected, and project a first message 1820, such as “entrance doorbell was generated”, at the moved entrance door 1810, which is information related to the first sound.

Referring to FIG. 18B, when second sound corresponding to a human voice is detected outside the entrance door, the electronic device 100 may recognize the second sound through the STT module, acquire text corresponding to the second sound, “Hello, I'm a new neighbor next door, I just wanted to say hello,” and project a second message 1830 including the acquired text at the currently located entrance door 1810.

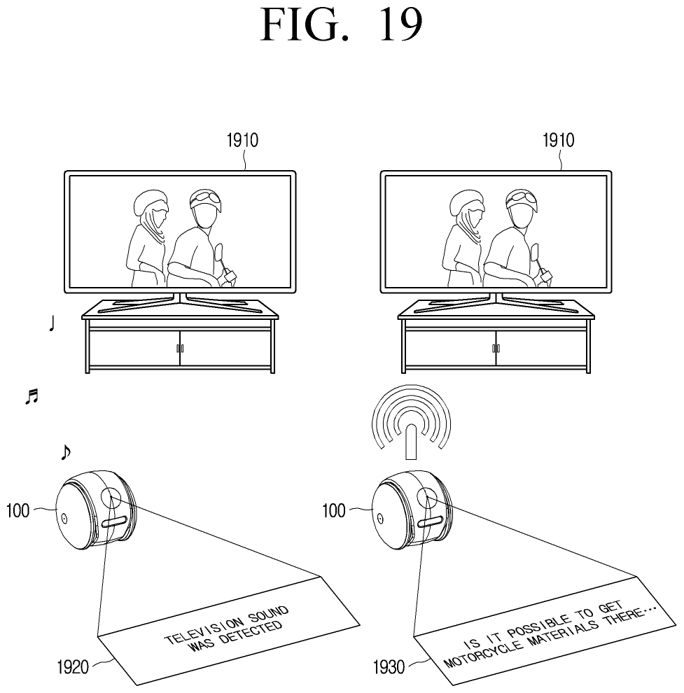

FIG. 19 is a view provided to explain a method for providing a message including information about sound generated in a display device according to an embodiment of the disclosure.

Referring to FIG. 19, in addition, the electronic device 100 may recognize sound generated by the display device and project subtitles corresponding to the sound generated by the display device.

Specifically, when sound is detected from a display device 1910, the electronic device 100 may move to the area where the display device 1910 is located and project a first message 1920, “TV sound was detected”, which is information about the sound.

In addition, when sound corresponding to a human voice is detected from the display device 1910, the electronic device 100 may recognize the sound output by the display device 1910 through the STT module to acquire text corresponding to the sound. Subsequently, the electronic device 100 may project a second message 1930 including the text corresponding to the acquired sound, i.e., subtitles, in the direction of the user in the area where the display device 1910 is located.

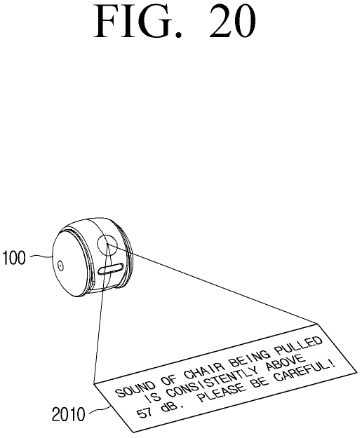

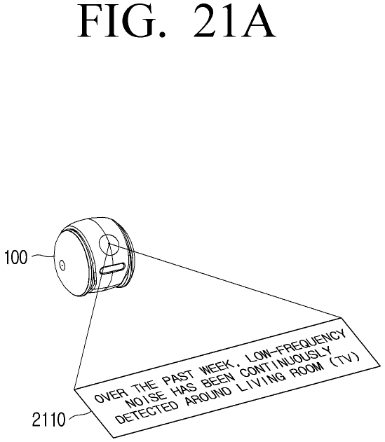

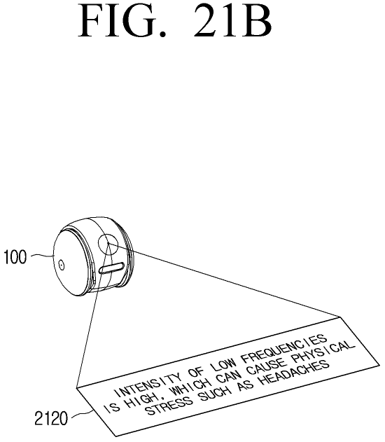

FIGS. 20, 21A, and 21B are views provided to explain a method for providing a message including information related to a noise generated within a home according to various embodiments of the disclosure.

Referring to FIGS. 20, 21A, and 21B, specifically, the electronic device 100 may store information about standards for a noise that may be generated within a home where the electronic device 100 is located. For example, the electronic device 100 may store information about acceptable inter-floor noise standards in the apartment where the electronic device 100 is located.

In addition, when the sound generated within the home exceeds a threshold of noise that may be generated within the home, the electronic device 100 may project a message that includes information about the detected sound and a warning about the noise. For example, when a chair dragging sound that exceeds a noise threshold is detected, the electronic device 100 may project a message that includes information about the chair dragging sound and a message 2010 including a warning about the noise, such as “The chair dragging sound is consistently above 57 dB. Please pay attention!” in the direction of the user.

In this case, when sound outside the noise threshold is detected more than a preset number of times, or when the volume of the sound outside the noise threshold is above a threshold value, the electronic device 100 may provide a message 2010 as shown in FIG. 20. In addition, the electronic device 100 may provide the message 2010 as shown in FIG. 20 based on the time of day that the noise was generated (e.g., 10:00 PM to 7:00 AM).

Further, the electronic device 100 may detect a low-frequency noise that is inaudible to humans but may cause stress within the home where the electronic device 100 is located, and provide information about the detected noise to the user. For example, when the electronic device 100 detects a low-frequency noise below a preset frequency (e.g., 100 Hz) for a preset amount of time or at a preset interval, the electronic device 100 may obtain information about the low-frequency noise (e.g., the location, duration, repetition time of the low-frequency noise, or the like) and project a message including information about the low-frequency noise. For example, as shown in FIG. 21A, the electronic device 100 may project a first message 2110 stating, “A low frequency noise has been consistently detected around the living room (TV) for the past one week” in the direction of the user.

In addition, the electronic device 100 may project a message including information about the effect of the low frequency noise on the user's body. For example, as shown in FIG. 21B, the electronic device 100 may project a second message 2120 stating, “The high intensity of the low frequency may cause physical stress, such as headaches” in the direction of the user.

As described above, by projecting information about various sounds generated within the home as messages, it is possible to provide information about a situation in the home to users with weak hearing or users who are in a situation where they are unable to perceive sound more quickly and accurately.

Meanwhile, the order shown in the flowcharts according to the various embodiments described above is only one example, and each of the steps shown in the flowcharts may be performed in parallel, and the order of each of the steps included in the flowcharts may be changed.

Meanwhile, the methods according to the various embodiments may be included and provided in a computer program product. The computer program product may be traded as a product between a seller and a purchaser. The computer program product may be traded as a product between a seller and a purchaser. The computer program product can be distributed in the form of a storage medium that is readable by machines (e.g., compact disc read only memory (CD-ROM)), or distributed directly on-line (e.g., download or upload) through an application store (e.g., PlayStore™), or between two user devices (e.g., smartphones). In the case of on-line distribution, at least a portion of a computer program product (e.g., a downloadable app) may be stored in a storage medium readable by machines, such as the server of the manufacturer, the server of the application store, or the memory of the relay server at least temporarily, or may be generated temporarily.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage such as, for example, storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

Various embodiments according to the disclosure may be implemented in software including an instruction stored in a machine-readable storage medium (e.g., computers). A machine may be a device that invokes the stored instruction from the storage medium and is operable based on the invoked instruction, and may include an electronic device (e.g., a TV) according to embodiments disclosed herein.

Meanwhile, the machine-readable storage medium may be provided in the form of a non-transitory storage medium. Here, the ‘non-temporary storage medium’ only means that it is a tangible device and does not include signals (e.g., electromagnetic waves), and this term does not distinguish between a case in which data is stored semi-permanently in a storage medium and a case in which data is stored temporarily. For example, the ‘non-temporary storage medium’ may include a buffer in which data is temporarily stored.

In case that the instruction is executed by a processor, the processor may directly perform a function corresponding to the instruction or other components may perform the function corresponding to the instruction under control of the processor. The instruction may include codes provided or executed by a compiler or an interpreter.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a driving part configured to drive the electronic device;
a microphone configured to receive audio;
a camera;
a projection part configured to project an image;
memory storing one or more computer programs; and
one or more processors communicatively coupled to the driving part, the microphone, the camera, the projection part, and the memory,
wherein one or more computer programs include computer-executable instructions that, when executed by the one or more processors individually or collectively, cause the electronic device to:
obtain information about audio generated by an object located in an indoor space through the microphone while travelling through the driving part, and obtain an image of the object through the camera,
obtain information about expected audio related to the object based on the image of the object, and store information about the audio generated by the object and information about the expected audio on a map corresponding to the indoor space,
based on sound being detected within the indoor space, identify an object related to the detected sound based on information about audio stored on the map, and
control the projection part to project a message including information about the sound based on information about the related object and the sound.

2. The device of claim 1, further comprising:
a communication interface,
wherein the one or more computer programs further include computer-executable instructions that, when executed by the one or more processors individually or collectively, cause the electronic device to:
obtain identification information of the object based on the image of the object,
transmit the obtained identification information of the object to an external server through the communication interface, and
obtain information about expected audio that could be generated by the object, from the external server.

3. The device of claim 1, wherein the one or more computer programs further include computer-executable instructions that, when executed by the one or more processors individually or collectively, cause the electronic device to:
obtain information about urgent audio requiring an urgent response in relation to a location where the object is located; and
store the urgent audio on a map corresponding to the indoor space.

4. The device of claim 1, wherein the one or more computer programs further include computer-executable instructions that, when executed by the one or more processors individually or collectively, cause the electronic device to:
identify whether an object related to the detected sound exists based on information about audio stored on the map;
based on identifying that an object related to the detected sound exists, identify whether the sound is generated by a registered human object or a registered inanimate object;
based on identifying that the detected sound is sound generated by the registered human object, control the driving part to identify a location of the registered human object and move to the location of the human object; and
based on the human object existing at the moved location, control the projection part to project a message including a text recognizing the sound around the human object.

5. The device of claim 4, wherein the one or more computer programs further include computer-executable instructions that, when executed by the one or more processors individually or collectively, cause the electronic device to:
based on the human object being an unregistered person or the human object not existing at the moved location, control the projection part to project a message including information about an estimated location of the human object and a text recognizing the sound.

6. The device of claim 4, wherein the one or more computer programs further include computer-executable instructions that, when executed by the one or more processors individually or collectively, cause the electronic device to:
based on identifying that the detected sound is sound generated by the registered inanimate object, determine an importance of the detected sound according to a pre-stored standard; and
control the projection part to project a message including information about the sound at a current location or at a location where the sound is generated according to the importance of the detected sound.

7. The device of claim 6, wherein the one or more computer programs further include computer-executable instructions that, when executed by the one or more processors individually or collectively, cause the electronic device to:
based on identifying that the detected sound is urgent sound, determine that the sound has a first importance;
based on a waveform of the detected sound being repeated more than a preset number of times, the detected sound being matched to audio including irregular noises among audio matched to the registered inanimate object, or the detected sound being identified as a call tone, determine that the sound has a second importance; and
based on identifying that the sound has neither the first importance nor the second importance, determine that the sound has a third importance.

8. The device of claim 7, wherein the one or more computer programs further include computer-executable instructions that, when executed by the one or more processors individually or collectively, cause the electronic device to:
based on the importance of the detected sound being the first importance, control the driving part to output a notification message to a user and move to a location where the detected sound is generated, and control the projection part to project a message including information about the sound at the location where the sound is generated;
based on the importance of the detected sound being the second importance, output a message inquiring a user about whether to move to a location where the detected sound is generated, based on the user moving to the location where the detected sound is generated, control the projection part to project a message including information about the sound at the location where the sound is generated, and based on the user not moving to the location where the detected sound is generated, control the projection part to project a message including information about the location where the sound is generated and information about the sound; and
based on the importance of the detected sound being the third importance, control the projection part to project a message including information about the sound at a current location, to the user.

9. The device of claim 5, wherein the one or more computer programs further include computer-executable instructions that, when executed by the one or more processors individually or collectively, cause the electronic device to:
based on identifying that the detected sound is sound generated by the unregistered person or the human object, identify an importance of the detected sound based on at least one of a magnitude of the detected sound or a duration of the detected sound.

10. The device of claim 8, wherein the one or more computer programs further include computer-executable instructions that, when executed by the one or more processors individually or collectively, cause the electronic device to:
based on the importance of the detected sound being the first importance, control the driving part to output a notification message to a user and move to the location where the detected sound is generated, and control the projection part to project a message including information about the sound at the location where the sound is generated;
based on the importance of the detected sound being the second importance, control the projection part to project a message including information about the sound in a direction corresponding to the location where the sound is generated by a current location; and
based on the importance of the detected sound being the third importance, output no message.

11. A method of controlling an electronic device, the method comprising:
obtaining information about audio generated by an object located in an indoor space through a microphone while the electronic device is travelling, and obtaining an image of the object through a camera;
obtaining information about expected audio related to the object based on the image of the object, and storing information about the audio generated by the object and information about the expected audio on a map corresponding the indoor space;
based on sound being detected within the indoor space, identifying an object related to the detected sound based on information about audio stored on the map; and
projecting a message including information about the sound based on information about the related object and the sound.

12. The method of claim 11, wherein the storing of the information about the audio comprises:
obtaining identification information of the object based on the image of the object;
transmitting the obtained identification information of the object to an external server; and
obtaining information about expected audio that could be generated by the object, from the external server.

13. The method of claim 11, wherein the storing of the information about the audio comprises:
obtaining information about urgent audio requiring an urgent response in relation to a location where the object is located; and
storing the urgent audio on a map corresponding to the indoor space.

14. The method of claim 11,
wherein the identifying of the object comprises:
identifying whether an object related to the detected sound exists based on information about audio stored on the map, and
based on identifying that an object related to the detected sound exists, identifying whether the sound is generated by a registered human object or a registered inanimate object, and
wherein the projecting of the message comprises:
based on identifying that the detected sound is sound generated by the registered human object, identifying a location of the registered human object and moving to the location of the human object, and
based on the human object existing at the moved location, projecting a message including a text recognizing the sound around the human object.

15. The method of claim 14, wherein the projecting of the message comprises:
based on the human object being an unregistered person or the human object not existing at the moved location, projecting a message including information about an estimated location of the human object and a text recognizing the sound.

16. The method of claim 14, further comprising:
based on identifying that the detected sound is sound generated by the registered inanimate object, determining an importance of the detected sound according to a pre-stored standard; and
controlling a projection part to project a message including information about the sound at a current location or at a location where the sound is generated according to the importance of the detected sound.

17. The method of claim 16, further comprising:
based on identifying that the detected sound is urgent sound, determining that the sound has a first importance;
based on a waveform of the detected sound being repeated more than a preset number of times, the detected sound being matched to audio including irregular noises among audio matched to the registered inanimate object, or the detected sound being identified as a call tone, determining that the sound has a second importance; and
based on identifying that the sound has neither the first importance nor the second importance, determining that the sound has a third importance.

18. The method of claim 17, further comprising:
based on the importance of the detected sound being the first importance, control a driving part to output a notification message to a user and move to a location where the detected sound is generated, and control the projection part to project a message including information about the sound at the location where the sound is generated;
based on the importance of the detected sound being the second importance, output a message inquiring a user about whether to move to a location where the detected sound is generated, based on the user moving to the location where the detected sound is generated, control the projection part to project a message including information about the sound at the location where the sound is generated, and based on the user not moving to the location where the detected sound is generated, control the projection part to project a message including information about the location where the sound is generated and information about the sound; and
based on the importance of the detected sound being the third importance, control the projection part to project a message including information about the sound at a current location, to the user.

19. One or more non-transitory computer-readable storage media storing computer-executable instructions that, when executed by one or more processors of an electronic device individually or collectively, cause the electronic device to perform operations, the operations comprising:
obtaining information about audio generated by an object located in an indoor space through a microphone while the electronic device is travelling, and obtaining an image of the object through a camera;
obtaining information about expected audio related to the object based on the image of the object, and storing information about the audio generated by the object and information about the expected audio on a map corresponding the indoor space;
based on sound being detected within the indoor space, identifying an object related to the detected sound based on information about audio stored on the map; and
projecting a message including information about the sound based on information about the related object and the sound.

20. The one or more non-transitory computer-readable storage media of claim 19, the operations further comprising:
obtaining identification information of the object based on the image of the object;
transmitting the obtained identification information of the object to an external server; and
obtaining information about expected audio that could be generated by the object, from the external server.
